(19) United States
(12) Patent Application Publication
(10) Pub. No.: US 2015/0369199 A1
(43) Pub. Date: Dec. 24, 2015

(54) AUTOMATIC STOP/RESTART CONTROL SYSTEM FOR AN INTERNAL COMBUSTION ENGINE AND VARIABLE VALVE ACTUATING APPARATUS

(71) Applicant: Hitachi Automotive Systems. Ltd., Hitachinaka-shi (JP)

(72) Inventor: Makoto NAKAMURA, Zushi-shi (JP)

(73) Assignee: Hitachi Automotive Systems, Ltd., Hitachinaka-shi (JP)

(21) Appl. No.: 14/658,635

(22) Filed: Mar. 16, 2015

(30) Foreign Application Priority Data
Jun. 20, 2014 (JP) 2014-126766

(51) Int. Cl. F02N 11/08; F02D 13/02

(52) U.S. Cl. CPC F02N 11/0803; F02D 13/0203; F02D 2013/0292

(57) ABSTRACT

An automatic stop/restart control system for an internal combustion engine comprising: an engine stop device configured to stop fuel injection from a fuel injection valve in response to generation of an engine stop request during an operation of an internal combustion engine; and a restart device configured to restart the fuel injection from the fuel injection valve and opening an exhaust valve in a vicinity of a bottom dead center on an expansion stroke end side in response to generation of a restart request by a driver in a course of a decrease in number of revolutions of the internal combustion engine during stop of the fuel injection by the engine stop device.

### TECHNICAL FIELD

The present invention relates to an automatic stop/restart control system for an internal combustion engine, which has a function of restarting an internal combustion engine in a course of a decrease in a rotational speed of the internal combustion engine as a result of automatic stop control, and to a variable valve actuating apparatus to be used in this system.

### BACKGROUND ART

In recent years, an increasing number of vehicles have an automatic stop/restart control system (so-called start-stop control system) for an internal combustion engine installed thereon in order to improve fuel economy, reduce exhaust emission, and the like. The related-art general start-stop control system stops, when a driver stops a vehicle, fuel injection so as to automatically stop an internal combustion engine, and then, when the driver carries out an operation (brake release operation or accelerator depression operation) to start the vehicle, automatically supplies a current to a starter or a motor used also as a starter so as to crank and restart the internal combustion engine.

In this start-stop control system, a restart request may be generated immediately after generation of an automatic stop request in the course of a decrease in the rotational speed of the internal combustion engine as a result of the stop of the fuel injection. For example, when the driver depresses a brake pedal in a state in which an intersection signal is “red”, the automatic stop control is carried out, and the rotational speed of the internal combustion engine decreases, but when the state of the intersection signal transitions from “red” to “green” in the course of the decrease, the driver switches from the depression on the brake pedal to depression on an accelerator pedal.

Such generation of the restart (re-acceleration) request in the course of the decrease in the rotational speed is referred to as “change of mind (COM)”. When “change of mind” occurs, and the current is supplied to the starter to crank and restart the internal combustion engine after the complete stop of the rotation of the internal combustion engine, a period is required from the generation of the restart (re-acceleration) request until the completion of the restart, and the driver feels a delay (slowness) of the restart.

Moreover, in a start-stop control system including a starter of a constant mesh type in which a pinion of the starter always meshes with a ring gear of the internal combustion engine even during the operation of the internal combustion engine, when the restart request is generated during the decrease of the rotational speed of the internal combustion engine as a result of the stop of the fuel injection, the current may be supplied to the starter so as to restart the internal combustion engine before the rotation of the internal combustion engine stops. However, this configuration cannot avoid an increase in the number of times of activation of the starter, and there is a fear of a decrease in durability of the starter.

Therefore, the following configuration has been proposed. When the restart request is generated in the course of the decrease in the rotational speed of the internal combustion engine as a result of the stop of the fuel injection by the start-stop control, and when the rotational speed of the internal combustion engine is in a rotational speed area where the internal combustion engine can be started without using the starter (can be restarted only by the fuel injection), the internal combustion engine is restarted only by the fuel injection without using the starter, in other words, so-called starter-less start is carried out.

In the start-stop control system employing a system of carrying out the starter-less start, at a time point when the restart request is generated during the decrease in the rotation after the stop of the fuel injection by the start-stop control, if the engine rotational speed is already less than a lower limit of the rotational speed area where the starter-less start is available, the starter-less start is difficult, and hence the starter needs to be used to restart the engine. In general, during the stop of the fuel injection, a throttle opening degree is controlled to be a fully closed position. Thus, a pumping loss increases due to an intake negative pressure, and the increase in the pumping loss quickly decreases the engine rotational speed. As a result, a period required until the rotational speed of the internal combustion engine reaches the lower limit of the rotational speed area where the starter-less start is available (a period in which the starter-less start can be carried out) after the generation of the automatic stop request decreases, and the number of times of the starter-less start decreases. Thus, the number of times of activation of the starter increases, resulting in a fear of a decrease in the durability of the starter.

In order to solve this problem, for example, in Japanese Patent Application Laid-open No. 2010-242621 (Patent Document 1), there has been proposed an automatic stop/restart control system capable of increasing the number of times of the starter-less start when the restart request is generated during the decrease in the rotation after the stop of the fuel injection by the start-stop control, to thereby reduce the number of times of the use of the starter and thus increase the durability of the starter.

In Japanese Patent Application Laid-open No. 2010-242621 (Patent Document 1), when the automatic stop request is generated during the operation of the internal combustion engine, the fuel injection is stopped, and the control amount in an air system is set to be increased in the air amount charged in a cylinder than that when the automatic stop request is generated, thereby decreasing the pumping loss. There is such a description that, as a result, the decrease in the rotational speed is made gentler during the stop of the fuel injection so as to increase the period required until the rotational speed reaches the lower limit of the rotational speed area where the starter-less start is available. As a result, the number of times of the starter less start can be increased. Moreover, the air amount charged in the cylinder can be increased in preparation for the generation of the restart request immediately after the generation of the automatic stop request, and thus the air amount charged in the cylinder can be changed to an air amount appropriate for the restart immediately after the generation of the restart request so as to carry out the restart.

In this way, the automatic stop/restart control system proposed in Japanese Patent Application Laid-open No. 2010-242621 (Patent Document 1) sets, in an extremely low rotation area such as at the restart of the internal combustion engine, the air amount charged in the cylinder to an increase side after the stop of the fuel injection so as to reduce a pumping loss and slow down a decrease in the rotational speed, thereby increasing the period required until the rotational speed reaches the lower limit of the rotational speed area where the starter-less start is available, resulting in an increase in the number of times of the starter-less start.

### CITATION LIST

### Patent Literature

Patent Document 1: Japanese Patent Application Laid-open No. 2010-242621

### SUMMARY OF INVENTION

Incidentally, the method described in Japanese Patent Application Laid-open No. 2010-242621 (Patent Document 1) can surely decrease the deceleration of the rotational speed so as to increase the period required until the rotational speed reaches the lower limit rotational speed permitting the starter-less start. However, an open time point of the exhaust valves is set to a second half of the expansion stroke in the internal combustion engine of this type. Therefore, at the restart after the stop of the fuel injection, a combustion gas acquired as a result of combustion of the supplied fuel is exhausted by the exhaust valve opening in the middle of the expansion stroke. Thus, expansion energy of the combustion gas cannot be effectively used in the expansion stroke, and thus a sufficient combustion torque (rotational force) is hard to be acquired at the restart. When a sufficient combustion torque cannot be acquired at the restart in the area where the rotational speed is low, the starter-less start becomes impossible, and the start needs to be changed to the start using the starter.

Thus, the method described in Japanese Patent Application Laid-open No. 2010-242621 (Patent Document) can carry out the starter-less start only down to a relatively high lower limit rotational speed, and there is such a problem in that the ratio of the starter-less start cannot be sufficiently increased.

On this occasion, it is conceivable to excessively increase the charging efficiency, or to set the air-fuel ratio to be rich in order to secure the combustion torque at the starter-less start. In this case, however, a peak combustion pressure excessively increases, and a rotational fluctuation of the engine at the starter-less start increases, which is suspected to make occupants feel sense of discomfort.

It is an object of the present invention to provide an automatic stop/restart control system for an internal combustion engine, which is capable of reducing the number of revolutions (rotational speed) permitting the starter-less start by effectively using the combustion torque of the combustion gas acquired by the combustion of the fuel when the restart request is generated after the stop of the fuel injection so as to restart the supply of the fuel in response to the restart request, thereby increasing the ratio of the starter-less start, and to provide a variable valve actuating apparatus to be used in this system.

Another object of the present invention is to provide an automatic stop/restart control system for an internal combustion engine, which is capable of suppressing the generation of the excessive peak combustion pressure, which generates the rotational fluctuation and thus makes the occupants feel the sense of discomfort, when the restart request is generated after the stop of the fuel injection so as to restart the supply of the fuel, thereby enabling a smooth starter-less start, and to provide a variable valve actuating apparatus to be used in this system.

According to one aspect of the present invention, an open timing of exhaust valves is retarded to the vicinity of a bottom dead center on an expansion stroke end side in a course of a decrease in a rotational speed of an internal combustion engine after stop of fuel injection, thereby effectively using a combustion torque of a combustion gas of a fuel caused by the fuel injection upon restart.

According to one aspect of the present invention, the open timing of the exhaust valves is retarded to the vicinity of the bottom dead center on the expansion stroke end side in the course of the decrease in the rotational speed of the internal combustion engine after the stop of the fuel injection, thereby effectively using the combustion torque of the combustion gas of the fuel caused by the fuel injection upon the restart, and a close timing of intake valves is changed to the vicinity of a bottom dead center on an intake stroke end side, thereby suppressing a discharge of fresh air backward to the intake system side upon the transition to a compression stroke.

### BRIEF DESCRIPTION OF DRAWINGS

FIG. 1 is a configuration diagram of a control system for an internal combustion engine to which the present invention is applied.

FIG. 2 is a configuration diagram of a variable valve actuating system illustrated in FIG. 1.

FIG. 3A is an operation explanatory diagram for minimum lift control by a lift control mechanism, which is a variable valve actuating apparatus.

FIG. 3B is an operation explanatory diagram for maximum lift control by the lift control mechanism, which is the variable valve actuating apparatus.

FIG. 4A is a configuration diagram illustrating a drive mechanism in a state of the minimum lift control by the lift control mechanism.

FIG. 4B is a configuration diagram illustrating the drive mechanism in a state of the maximum lift control by the lift control mechanism.

FIG. 5 is a characteristic graph showing a lift characteristic of the lift control mechanism.

FIG. 6A is a configuration diagram illustrating a state at a most advanced phase of a valve timing control mechanism, which is the variable valve actuating apparatus.

FIG. 6B is a configuration diagram illustrating a state at a most retarded phase of the valve timing control mechanism, which is the variable valve actuating apparatus.

FIG. 7 is a cross sectional view illustrating a longitudinal cross section of the valve timing control mechanism.

FIG. 8A is an explanatory diagram illustrating valve timings of exhaust valves and intake valves when a restart is carried out from an automatic stop state according to an embodiment of the present invention.

FIG. 8B is another explanatory diagram illustrating the valve timings of the exhaust valves and the intake valves when the restart is carried out from the automatic stop state according to the embodiment of the present invention.

FIG. 9A is an explanatory diagram illustrating the valve timings of the intake valves and the exhaust valves when a rotational speed is increased and decreased according to the embodiment of the present invention.

FIG. 9B is another explanatory diagram illustrating the valve timings of the intake valves and the exhaust valves when the rotational speed is increased and decreased according to the embodiment of the present invention.

FIG. 10 is an explanatory diagram illustrating an operation of an automatic stop/restart control system when the restart is carried out from the automatic stop state according to the embodiment of the present invention.

FIG. 11 is a flowchart for carrying out the operation of the automatic stop/restart control system according to the embodiment of the present invention.

FIG. 12A is an explanatory diagram illustrating an operation of an automatic stop/restart control system when the restart is carried out from the automatic stop state according to another embodiment of the present invention.

FIG. 12B is a flowchart for carrying out the operation of the automatic stop/restart control system according to the another embodiment of the present invention.

FIG. 13A is an explanatory diagram illustrating valve timings of exhaust valves and intake valves by a valve timing control mechanism when the restart is carried out from the automatic stop state according to further another embodiment of the present invention.

FIG. 13B is another explanatory diagram illustrating the valve timings of the exhaust valves and the intake valves by the valve timing control mechanism when the restart is carried out from the automatic stop state according to the further another embodiment of the present invention.

FIG. 14 is an explanatory diagram relating to ramp sections of the exhaust valves and the intake valves.

### DESCRIPTION OF EMBODIMENTS

Now, a detailed description is given of embodiments of the present invention with reference to the drawings, but the present invention is not limited to the following embodiments, and includes various modifications and application examples in the scope thereof within a technical concept of the present invention.

Before specific examples of the present invention are described, a brief description is given of a configuration of a control system for an internal combustion engine to which the present invention is applied, a configuration of a variable valve actuating system, and configurations of a lift control mechanism and a valve timing control mechanism which are a variable valve actuating apparatus.

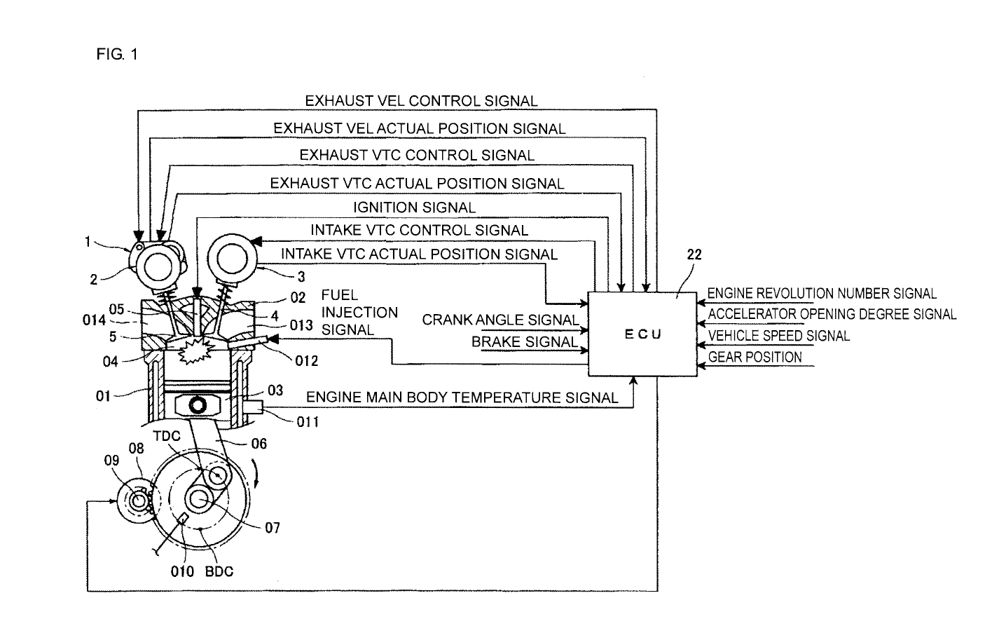

In FIG. 1, a combustion chamber 04 is formed by a piston 03 between a cylinder block 01 and a cylinder head 02, and an ignition plug 05 is arranged approximately at a center position of the cylinder head 02. The piston 03 is connected to a crankshaft 07 via a connecting rod 06 having one end connected to a piston pin, and the crankshaft 07 is configured to be driven via a pinion gear mechanism 09 by a starter motor 08 so that a normal start when the engine is cold and an automatic start after an idle reduction are carried out. It should be noted that a crank angle and the number of revolutions (hereinafter referred to as “rotational speed”) of the crankshaft 07 are detected by a crank angle sensor 010 described later.

A water temperature sensor 011 for detecting a water temperature in a water jacket is mounted to the cylinder block 01, and a fuel injection valve 012 for injecting a fuel into the combustion chamber 04 is mounted on the cylinder head 02. Further, two intake valves 4 and two exhaust valves 5 for opening and closing intake ports 013 and exhaust ports 014 formed inside the cylinder head 02 are respectively mounted per cylinder in a freely slidable manner, and the variable valve actuating apparatus is arranged on the intake valve 4 side and the exhaust valve 5 side. A valve timing control mechanism (VTC) 3 is arranged on the intake valve side, and a lift control mechanism (VEL) 1 is arranged on the exhaust valve side. It should be noted that the valve timing control mechanism (VTC) 3 may be arranged on the exhaust valve side depending on the case. Illustrated sensor signals are input to a control apparatus 22, and drive signals for control elements are output from the control apparatus 22.

The starter motor 08 of FIG. 1 is a general starter motor including a motor main unit using a battery as a power supply, the pinion gear mechanism 09 meshing with a ring gear fitted on an outer periphery of a flywheel so as to transmit power, and the like. Only when a current is supplied to the starter motor 08 upon a start or a restart, a pinion gear of the pinion gear mechanism 09 moves forward, and meshes with the ring gear of the internal combustion engine, thereby transmitting rotation of the starter motor 08 to the well-known ring gear for carrying out cranking. It should be noted that when the internal combustion engine successfully starts, and the current supply to the starter motor 08 is stopped, the pinion gear is pushed back, and the meshing with the ring gear is released.

On this occasion, as described later, this embodiment is intended to control the exhaust valves 5 at a predetermined specific open timing, and to control the intake valves 4 at a predetermined specific close timing. Therefore, the type of the starter is not limited. A starter configured so that the pinion gear and the ring gear always mesh with each other or a starter configured to rotate a crank pulley by means of belt drive by using a motor for a hybrid vehicle or the like can be employed.

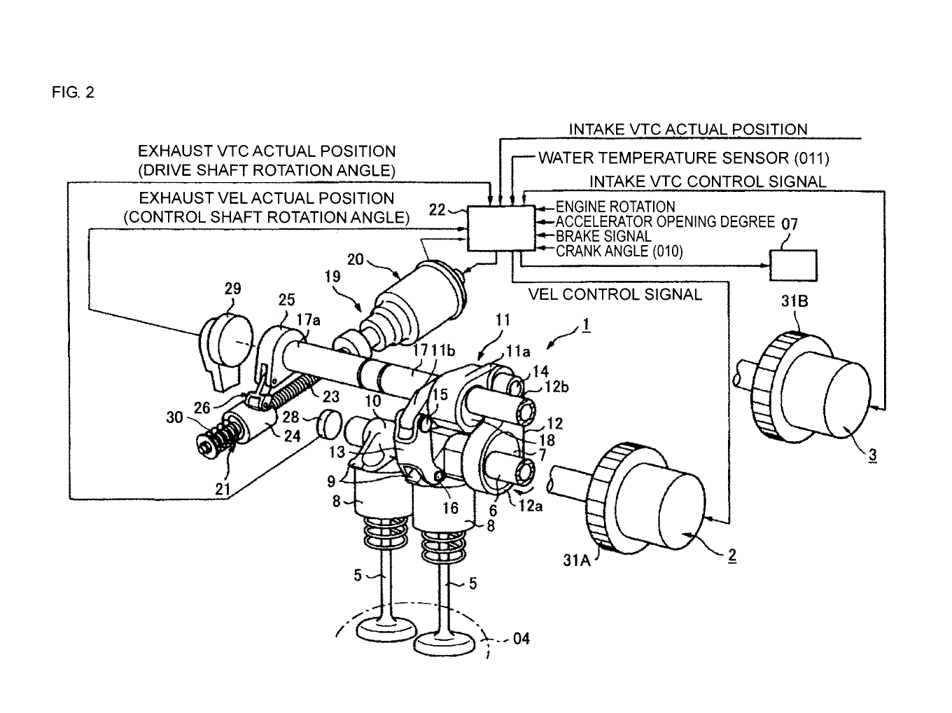

As illustrated in FIGS. 2 to 7, the variable valve actuating apparatus includes the exhaust VEL 1, which is the lift control mechanism, for controlling a valve lift and an operation angle (open period) of the exhaust valves 5 of the internal combustion engine, an exhaust VTC 2, which is the valve timing control mechanism, for controlling an open/close timing (valve timing) of the exhaust valves 5, and the intake VTC 3 for controlling an open/close timing of the intake valves 4. Moreover, respective actions of the exhaust VEL 1, the exhaust VTC 2, and the intake VTC 3 are controlled by the controller 22 depending on an engine operation state.

The exhaust VEL 1 has the same configuration as that described, for example, in Japanese Patent Application Laid-open No. 2003-172112 (applied on the intake valve side) previously filed by the applicant, and thus refer to this publication for details. Moreover, the intake VTC 3 also has the same configuration as that described, for example, in Japanese Patent Application Laid-open No. 2012-127219 previously filed by the applicant, and thus refer to this publication for details.

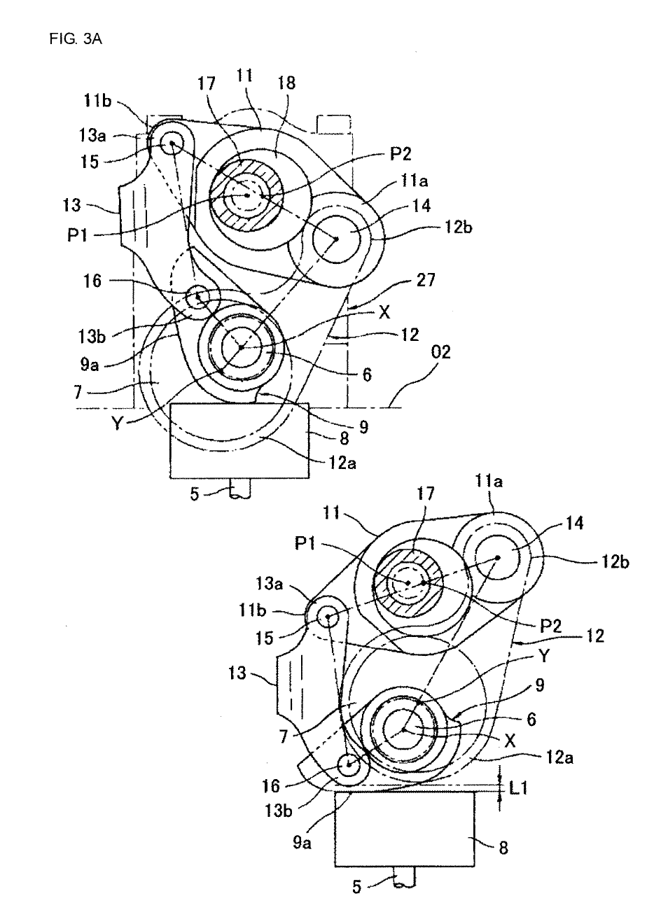

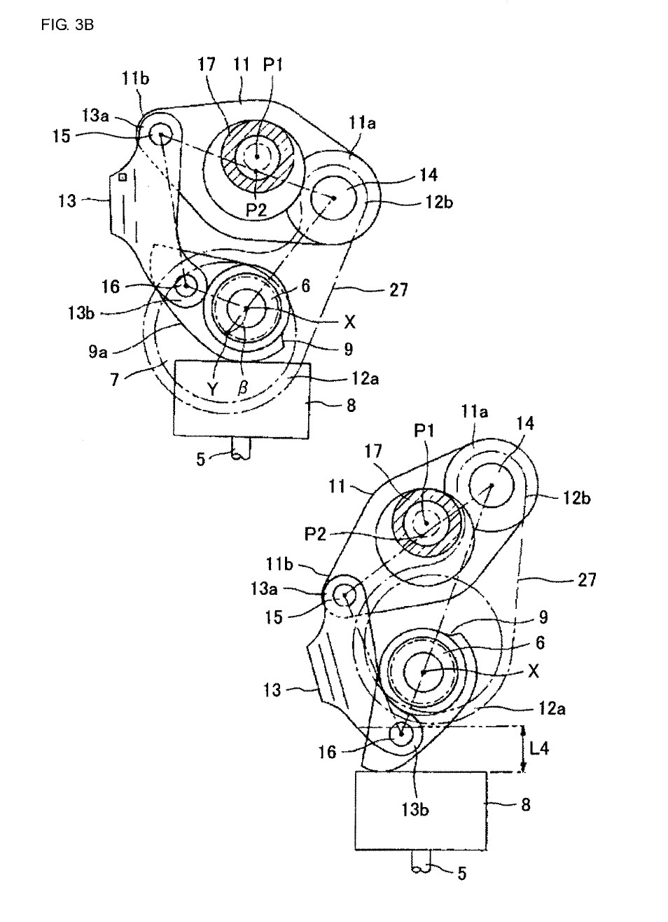

Referring to FIGS. 2, 3A, and 3B, a brief description is given of the exhaust VEL 1. The exhaust VEL 1 includes a hollow drive shaft 6 supported in a freely rotatable manner by a bearing 27 mounted on an upper portion of the cylinder head 02, a rotation cam 7 fixed to an outer peripheral surface of the drive shaft 6 by means of press-fit or the like, two swing cams 9 supported in a freely swingable manner on the outer peripheral surface of the drive shaft 6 and configured to come in sliding contact with upper surfaces of valve lifters 8 arranged at upper ends of the exhaust valves 5, to thereby open the exhaust valves 5, and a transmission mechanism interposed between the rotation cam 7 and the swing cams 9, to thereby convert the rotational force of the rotation cam 7 into a swing motion, and transmit the swing motion to the swing cams 9 as the swing force.

A rotational force is transmitted by a timing chain from the crankshaft 07 to the drive shaft 6 via a timing sprocket 31A arranged on one end of the drive shaft 6, and a rotational direction thereof is set as clockwise (direction of the arrow) in FIG. 2. It should be noted that a phase between the drive shaft 6 and the timing sprocket 31A does not change. In other words, according to this embodiment, the exhaust VTC 2 is installed, but is not used, and a phase conversion is not carried out. Thus, the exhaust VTC 2 can be omitted, or, conversely, the exhaust VTC 2 may be used in place of the exhaust VEL 1. A description is later given of this example.

The rotation cam 7 has an approximately ring shape, and is fixed to the drive shaft 6 passing through a drive shaft insertion hole axially formed inside. An axial center Y of a cam main body is offset from an axial center X of the drive shaft 6 by a predetermined amount in a radial direction.

The swing cams 9 are formed integrally with both ends of a cylindrical camshaft 10, and the camshaft 10 is supported in a freely rotatable manner by the drive shaft 6 via an inner peripheral surface of the camshaft 10. Moreover, a cam surface 9a including a base circle surface, a ramp surface, and a lift surface is formed on a bottom surface of the swing cam 9. The base circle surface, the ramp surface, and the lift surface come in abutment against predetermined positions of the upper surface of each valve lifter 8 depending on a swing position of the swing cam 9.

The transmission mechanism includes a rocker arm 11 arranged above the drive shaft 6, a link arm 12 for linking one end 11a of the rocker arm 11 and the rotation cam 7 to each other, and a link rod 13 for linking the other end 11b of the rocker arm 11 and the swing cam 9 to each other. A base in a tubular shape formed at a center of the rocker arm 11 is supported in a freely rotatable manner by a control cam described later through a support hole. The one end 11a is connected in a freely rotatable manner to the link arm 12 by a pin 14, and the other end 11b is connected in a freely rotatable manner to one end 13a of the link rod 13 via a pin 15.

The cam main body of the rotation cam 7 is fitted in a freely rotatable manner into a fitting hole of the link arm 12, which is formed at a center position of an annular base end 12a. On the other hand, a protruding end 12b protruding from the base end 12a is connected to the one end 11a of the rocker arm 11 via the pin 14. The other end 13b of the link rod 13 is connected in a freely rotatable manner to a cam nose portion of the swing cam 9 via a pin 16. Moreover, a control shaft 17 is supported in a freely rotatable manner by the same bearing member above the drive shaft 6, and a control cam 18 fitted in a freely slidable manner into a support hole of the rocker arm 11, and serving as a swing fulcrum for the rocker arm 11 is fixed to an outer periphery of the control shaft 17. The control shaft 17 is arranged in the longitudinal direction of the engine in parallel with the drive shaft 6, and is controlled so as to rotate by a drive mechanism 19. On the other hand, the control cam 18 has a cylindrical shape, and a position of an axial center P2 is offset by a predetermined amount from an axial center P1 of the control shaft 17.

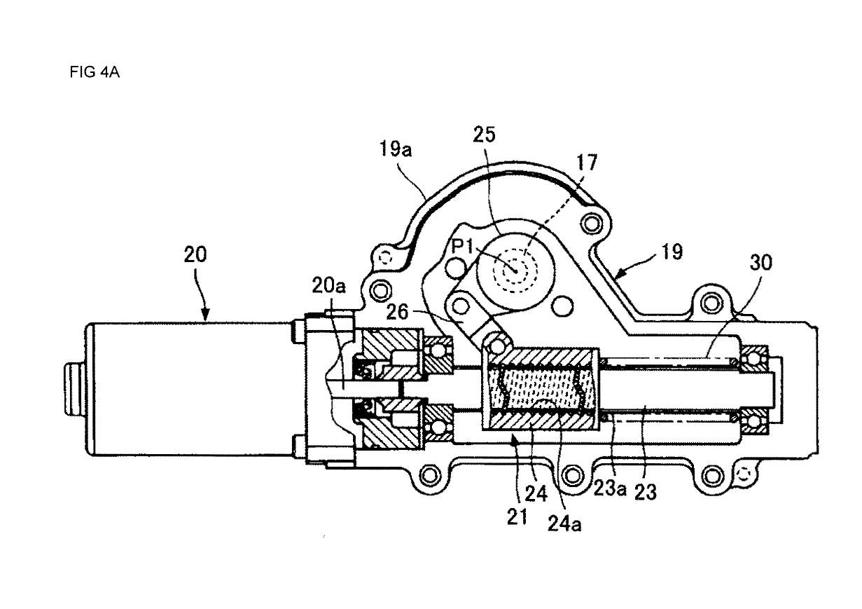

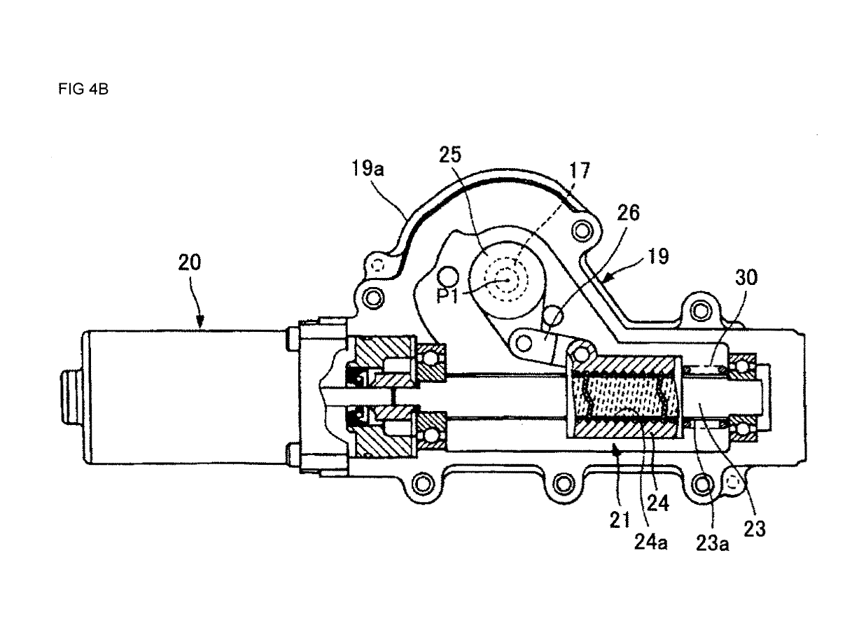

As illustrated in FIGS. 4A and 4B, the drive mechanism 19 includes an electric motor 20 fixed to one end of a casing 19a, and ball screw transmission mechanism 21 formed inside the casing 19a, for transmitting a rotational driving force of the electric motor 20 to the control shaft 17. The electric motor 20 is constructed by a DC motor of the proportional type, and is driven in response to the control signal from the controller 22 serving as a control mechanism for detecting the engine operation state.

The ball screw transmission mechanism 21 mainly includes a ball screw shaft 23 arranged approximately coaxially with a drive shaft 20a of the electric motor 20, a ball nut 24, which is a moving member, for threadedly engaging with an outer periphery of the ball screw shaft 23, a link arm 25 connected to one end of the control shaft 17 along a diametrical direction, and a link member 26 for linking the link arm 25 and the ball nut 24 to each other. On the ball screw shaft 23, a ball circulation groove 23a having a predetermined width is continuously formed in a helical form on an entire outer peripheral surface except for both ends. The ball screw shaft 23 is rotationally driven by the electric motor 20 connected to one end of the ball screw shaft 23 via the motor drive shaft.

The ball nut 24 is formed into an approximately cylindrical shape, has a guide groove 24a continuously formed in a helical form on an inner peripheral surface of the ball nut 24 so as to cooperate with the ball circulation groove 23a to hold a plurality of balls in a freely rollable manner, and is applied with an axial moving force while a rotational motion of the ball screw shaft 23 is converted into a liner motion of the ball nut 24 via the respective balls. Moreover, the ball nut 24 is biased toward the electric motor 20 side (minimum lift side) by a spring force of a coil spring 30, which is biasing member. Thus, when the engine is stopped, the ball nut 24 is axially moved to the minimum lift side along the axial direction of the ball screw shaft 23 by the spring force of the coil spring 30.

The controller 22 is built into an engine control unit (ECU), and detects a current engine operation state and an operation state of the vehicle based on a detection signal from the crank angle sensor 010 for detecting current engine revolution number (engine rotational speed) N and crank angle, and various information signals from an accelerator opening degree sensor, a vehicle speed sensor, a gear position sensor, a brake depression sensor, the water temperature sensor 011, and the like. Moreover, the controller 22 is configured to input a detection signal from a drive shaft angle sensor 28 for detecting a rotational angle of the drive shaft 6, and a detection signal from a potentiometer 29 for detecting a rotational position of the control shaft 17, thereby detecting a relative rotational angle of the drive shaft 6 with respect to the crank angle and valve lift amounts and the operation angles of the respective exhaust valves 5 and 5.

A description is now given of a basic operation of the exhaust VEL 1. When the ball screw shaft 23 rotates in one direction in a predetermined operation area by a rotational torque of the electric motor 20 rotationally driven in one direction by the control current from the controller 22, as illustrated in FIG. 4A, the ball nut 24 linearly moves maximally in one direction (a direction toward the electric motor 20) while assisted by the spring force of the coil spring 30. As a result, the control shaft 17 rotates in one direction via the link member 26 and the link arm 25.

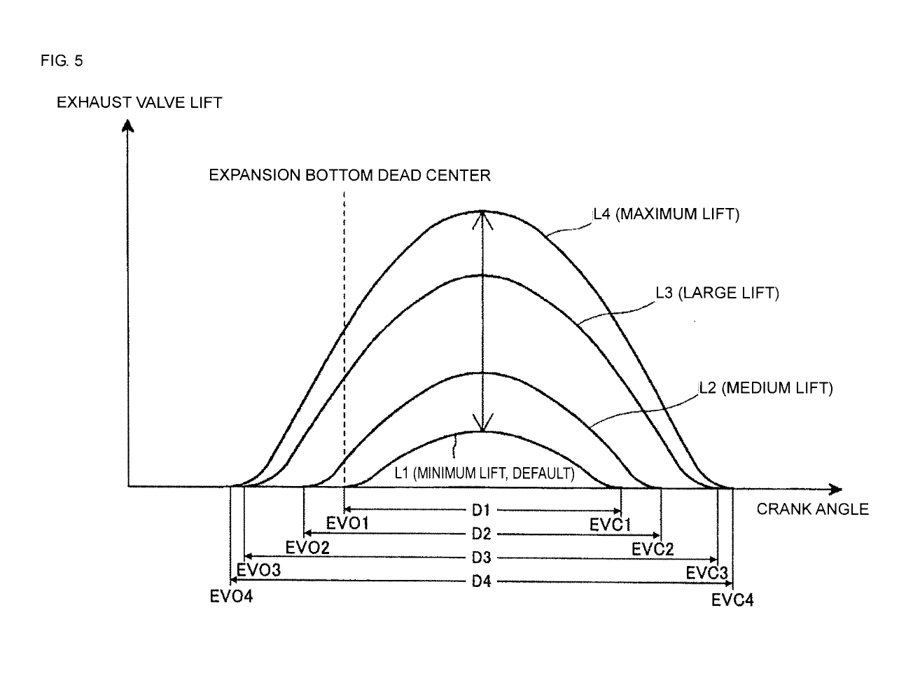

Thus, as illustrated in FIG. 3A, the axial center of the control cam 18 rotates at the same radius about the axial center of the control shaft 17, and a thick portion of the control cam 18 moves upward so as to separate from the drive shaft 6. As a result, a pivot point between the other end 11b of the rocker arm 11 and the link rod 13 moves upward with respect to the drive shaft 6. As a result, the cam nose portion side of each of the swing cams 9 is forcibly pulled upward via the link rod 13, and the entire swing cam 9 turns clockwise as illustrated in FIG. 3A. As a result, when the rotation cam 7 rotates and pushes upward the one end 11a of the rocker arm 11 via the link arm 12, a lift amount is transmitted to the swing cams 9 and the valve lifters 16 via the link rod 13. As a result, as indicated by the valve lift curve of FIG. 5, the valve lift amount of the exhaust valves 5 reaches the minimum lift (L1), and an operation angle D1 (open period represented by the crank angle) thereof decreases. The operation angle represents an angle from an open timing to a close timing of the lift of the exhaust valves 5.

Further, in a different operation state, the electric motor 20 rotates toward the other direction by the control signal from the controller 22. When this rotational torque is transmitted to the ball screw shaft 23, and the ball screw shaft 23 thus rotates, as a result of this rotation, the ball nut 24 translates toward the opposite direction, namely, the right direction of FIG. 4A by a predetermined amount against the spring force of the coil spring 30. As a result, the control shaft 17 is rotationally driven in a clockwise direction of FIG. 3A by a predetermined amount. As a result, the axial center of the control cam 18 is held at a rotational angle position below by a predetermined amount from the axial center P1 of the control shaft 17, and the thick portion moves downward. Therefore, the entire rocker arm 11 moves counterclockwise from the position of FIG. 3A. As a result, the cam nose portion side of each of the swing cams 9 is forcibly pushed down via the link rod 13, and the entire swing cam 9 slightly turns counterclockwise.

Thus, when the rotation cam 7 rotates so as to push up the one end 11a of the rocker arm 11 via the link arm 12, this lift amount is transmitted to the respective swing cams 9 and the valve lifters 8 via the link rod 13. As shown in FIG. 5, the lift amount of the exhaust valves 5 reaches a medium lift (L2) or a large lift (L3), and the operation angle also increases to D2 or D3.

Moreover, for example, when the state transitions to a high-rotation/high-load area, the electric motor 20 further rotates toward the other direction by the control signal from the controller 22 so as to move the ball nut 24 maximally rightward as illustrated in FIG. 4B. As a result, the control shaft 17 further rotates the control cam 18 in the clockwise direction of FIG. 3A so as to further turn the axial center P2 downward. Therefore, as illustrated in FIG. 3B, the entire rocker arm 11 moves further toward the drive shaft 6, and the other end 11b pushes the cam nose portion of the swing cam 9 downward via the link rod 13, thereby further turning the entire swing cam 9 counterclockwise by a predetermined amount.

Thus, when the rotation cam 7 rotates so as to push up the other end 11a of the rocker arm 11 via the link arm 12, this lift amount is transmitted to the swing cams 9 and the valve lifters 8 via the link rod 13. As shown in FIG. 5, the valve lift amount continuously increases from L2 or L3 to L4. As a result, an exhaust efficiency in the high-rotation area can be increased, thereby increasing the output. In other words, the lift amount of the exhaust valves 5 continuously changes from the medium lift L2 through the large lift L3 to the maximum lift L4 depending on the operation state of the engine. Thus, the operation angle of the respective exhaust valves 5 continuously changes from the minimum lift D1 to the maximum lift D4. Moreover, when the engine is stopped, as described above, the ball nut 24 is biased by the spring force of the coil spring 30 so as to automatically move toward the electric motor 20 side. The operation angle and the lift are thus maintained to the minimum operation angle D1 and the minimum lift L1 position (default position).

In other words, when conversion electric power (conversion energy) is not acting on the electric motor 20, the exhaust valves 5 are mechanically stabilized in the vicinity of the minimum lift (minimum operation angle), and the minimum lift (minimum operation angle) thus corresponds to a mechanically stable position (default). According to this embodiment, as described later, when the restart request is generated, as shown in FIG. 5, an open timing (EVO1) of the exhaust valves is set to the vicinity of the bottom dead center on an end side of an expansion stroke. As a result, the energy of the combustion gas generated during restart can be effectively used, and a detailed description is later given of this control. Moreover, since the open timing (EVO1) of the exhaust valves is also at the above-mentioned mechanically stable position (default), a conversion responsiveness can be increased by using mechanically stabilized energy when conversion is carried out toward this open timing.

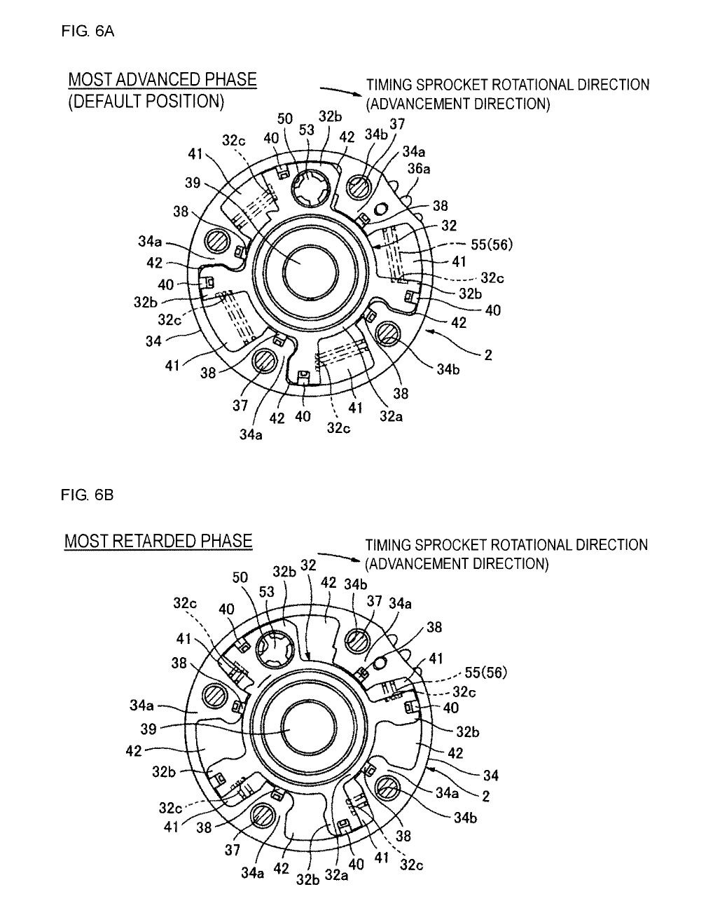

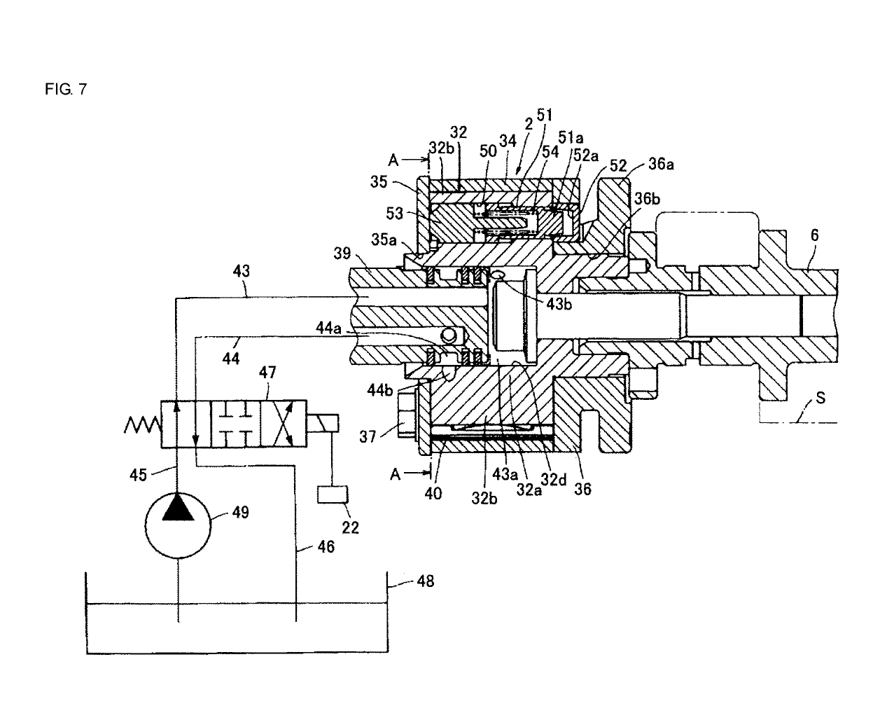

The intake VTC 3 is an intake VTC 3 of a so-called vane type, and includes, as illustrated in FIGS. 6A, 6B, and 7, a timing sprocket 31B rotationally driven by the crankshaft 07 of the engine, for transmitting the rotational driving force to the drive shaft 6, a vane member 32 fixed to an end of the drive shaft 6 and received in a freely rotatable manner in the timing sprocket 31B, and a hydraulic circuit for forward/backward rotating the vane member 32 by means of a hydraulic pressure.

The timing sprocket 31B includes a housing 34 for receiving the vane member 32 in a freely rotatable manner, a front cover 35 in a circular plate shape for closing a front end opening of the housing 34, and a rear cover 36 approximately in a circular plate shape for closing a rear end opening of the housing 34. These housing 34, front cover 35, and rear cover 36 are tightened together and integrally fixed in the axial direction of the drive shaft 6 by four small-diameter bolts 37. The housing 34 has a cylindrical shape having the openings formed at the front and rear ends, and shoes 34a, which are four partitions, are formed so as to protrude inward at positions separated from each other by approximately 90° in a peripheral direction of an inner peripheral surface.

Each of the shoes 34a has approximately a trapezoidal shape in a lateral cross section. Four bolt insertion holes 34b into each of which a shank of each of the bolts 37 is inserted are formed so as to axially pass through the shoes 34a approximately at the center positions. Further, a seal member 38 in a U shape and a plate spring (not shown) for inwardly pressing the seal member 38 are fitted into and held in a holding groove formed by cutting each inner end surface of the shoe 34a along the axial direction.

The front cover 35 is formed into a disk plate shape. A support hole 35a relatively large in diameter is drilled at the center of the front cover 35, and four bolt holes (not shown) are drilled through an outer periphery at positions corresponding to the respective bolt insertion holes 34b of the respective shoes 34a. In the rear cover 36, a gear part 36a meshing with a timing chain is integrally formed on a rear end side, and a bearing hole 36b large in the diameter is formed so as to axially pass through the rear cover 36 approximately at the center.

The vane member 32 includes a vane rotor 32a in an annular shape having a bolt insertion hole at the center, and four vanes 32b integrally formed at positions separated by approximately 90° in a peripheral direction of an outer peripheral surface of the vane rotor 32a. A small diameter tube part on the front end side of the vane rotor 32a is supported in a freely rotatable manner by the support hole 35a of the front cover 35, and a small diameter cylindrical part on the rear end side of the vane rotor 32a is supported in a freely rotatable manner by the bearing hole 36b of the rear cover 36. Moreover, the vane member 32 is axially fixed to the front end of the drive shaft 6 by a fixing bolt 57 axially inserted through the bolt insertion hole of the vane rotor 32a.

Each of three of the vanes 32b are formed into a relatively long rectangular shape, and the other vane 32b is formed into a wide trapezoidal shape. While widths of the three vanes 32b are approximately the same, a width of the other vane 32b is set to be larger than those of the three vanes 32b, resulting in a balance in the weight of the entire vane member 32. Moreover, each of the vanes 32b is arranged between the shoes 34a, and a seal member 40 in a U shape, which is held in sliding contact with an inner peripheral surface of the housing 34, and a plate spring for pressing the seal member 40 against the inner peripheral surface of the housing 34 are respectively fitted into and held in a narrow and long holding groove formed in each outer surface of the vane 32b in the axial direction. Moreover, two approximately circular recessed grooves 32c are formed on each of side surfaces of the vanes 32b on the opposite side to the rotational direction of the drive shaft 6. Moreover, each of four advanced-side hydraulic chambers 41 and four retarded-side hydraulic chambers 42 is partitioned and formed between a side surface of each of the shoes 34a and a side surface of each of the vanes 32b.

As illustrated in FIG. 7, the hydraulic circuit includes two systems of hydraulic passage, which are a first hydraulic passage 43 for supplying and discharging a hydraulic pressure of a working fluid to and from the respective advanced-side hydraulic chambers 41 and a second hydraulic passage 44 for supplying and discharging a hydraulic pressure of the working fluid to and from the respective retarded-side hydraulic chambers 42. A supply passage 45 and a drain passage 46 are respectively connected to both of the hydraulic passages 43 and 44 via an electromagnetic switching valve 47 for passage switching. While a one-way oil pump 49 for pressure-feeding oil in an oil pan 48 is arranged on the supply passage 45, a downstream end of the drain passage 46 communicates to the oil pan 48.

The first and second hydraulic passages 43 and 44 are formed inside a cylindrical passage construction part 39. One end of this passage construction part 39 is arranged so as to be inserted from the small diameter cylindrical part of the vane rotor 32a into a support hole 32d inside the vane rotor 32a, and the other end thereof is connected to the electromagnetic switching valve 47. Moreover, three ring-shaped seal members for partitioning and sealing one end sides of the respective hydraulic passages 43 and 44 are fitted and fixed between an outer peripheral surface of the one end of the passage construction part 39 and an inner peripheral surface of the support hole 14d.

The first hydraulic passage 43 includes an oil chamber 43a formed at an end on the drive shaft 6 side of the support hole 32d, and four branch passages 43b formed approximately radially inside the vane rotor 32a for communication between the oil chamber 43a and the respective advanced-side hydraulic chambers 41. On the other hand, the second hydraulic passage 44 is blocked inside the one end of the passage construction part 39, and includes a ring-shaped chamber 44a formed on the outer peripheral surface of the one end, and a second oil passage 44b formed by being bent into an approximately L shape inside the vane rotor 32 for communication between the ring-shaped chamber 44a and the respective retarded-side hydraulic chambers 42.

The electromagnetic switching valve 47 is a switching valve of a four-port/three-position type, and an inside valve body is configured to control relative switching between each of the hydraulic passages 43 and 44 and the supply passage 45 or the drain passage 46. The electromagnetic switching valve 47 is activated for the switching by the control signal from the controller 22. When the control current is not applied to the electromagnetic switching valve 47 of the intake VTC 3, the supply passage 45 communicates to the first hydraulic passage 43 communicating to the advanced-side hydraulic chambers 41, and the drain passage 46 communicates to the second hydraulic passage 44 communicating to the retarded-side hydraulic chambers 42. Moreover, the electromagnetic switching valve 47 is formed to mechanically take this position by a coil spring in the electromagnetic switching valve 47. The controller 22 is shared by the exhaust VEL 1. The controller 22 detects the engine operation state, and detects a relative rotational position between the timing sprocket 31B and the drive shaft 6 based on the signals from the crank angle sensor 010 and the drive shaft angle sensor 28.

Moreover, a lock mechanism, which is constraint mechanism for constraining and releasing the constraint of the rotation of the vane member 32 with respect to the housing 34, is provided between the vane member 32 and the housing 34. The lock mechanism is formed between the one vane 32b larger in the width and the rear cover 36, and includes a sliding hole 50 formed along the axial direction of the drive shaft 6 in the vane 32b, a lock pin 51 in a closed cylindrical shape arranged inside the sliding hole 50 in a freely slidable manner, an engagement hole 52a formed in an engagement hole construction part 52 in a cup shape in a lateral cross section, which is fixed to a fixing hole of the rear cover 36, for engaging and releasing a tapered tip portion 51a of the lock pin 51, and a spring member 54 held by a spring retainer 53 fixed to a bottom surface side of the sliding hole 50, for biasing the lock pin 51 toward the engagement hole 52a. The hydraulic pressure in the advanced-side hydraulic chambers 41 or the hydraulic pressure of the oil pump 49 is directly supplied, via an oil hole (not shown), to the engagement hole 52a.

Then, the tip portion 51a of the lock pin 51 engages with the engagement hole 52a by the spring force of the spring member 54 at a position where the vane member 32 is rotated to the most advanced side, to thereby lock the relative rotation between the timing sprocket 31B and the drive shaft 6. Moreover, the lock pin 51 is configured to be moved backward by the hydraulic pressure supplied from the advanced-side hydraulic chambers 41 to the inside of the engagement hole 52a or the hydraulic pressure of the oil pump 49, to thereby release the engagement with the engagement hole 52a. Moreover, a pair of coil springs 55 and 56, which are biasing members for rotationally biasing the vane member 32 toward the advanced side, are arranged between one side surface of each vane 32b and an opposing surface of each shoe 34a opposing this side surface. The coil springs 55 and 56 are arranged in parallel with each other at such a distance between the axes so as not to come in contact with each other at the maximum compressed deformation, and one end of each of the coil springs 55 and 56 is connected via a retainer in a thin plate shape (not shown), which is fitted into the recessed groove 32c of the vane 32b.

A description is now given of a basic operation of the intake VTC 3. First, when the engine is stopped, the output of the control current from the controller 22 to the electromagnetic switching valve 47 is stopped, and the valve body is mechanically brought into the default position illustrated in FIG. 6A by the spring forces of the coil springs 55 and 56. The supply passage 45 and the first hydraulic passage 43 on the advanced side are brought into communication to each other, and the drain passage 46 and the second hydraulic passage 44 are brought into communication to each other. Moreover, in this state in which the engine is stopped, the hydraulic pressure of the oil pump 49 does not act, and the supplied hydraulic pressure becomes 0.

Thus, as illustrated in FIG. 6A, the vane member 32 is rotationally biased to the most advanced side by the spring forces of the coil springs 55 and 56 so that one end surface of the one wide vane 32b abuts against one side surface of the one opposing shoe 34a. Simultaneously, the tip portion 51a of the lock pin 51 of the lock mechanism engages with the engagement hole 52a so as to stably hold the vane member 32 at the most advanced position. In other words, the most advanced position is the default position where the intake VTC 3 is mechanically stable. On this occasion, the default position is a position where the mechanical stability is automatically brought about in the non-active state, in other words, when the hydraulic pressure does not act.

Thus, when the output of the control current to the electromagnetic switching valve 47 is interrupted, and the hydraulic pressure does not thus act on the intake VTC 3, the vicinity of the most advanced position is the mechanically stable position (default). According to this embodiment, as described later, when the restart request is generated, a close timing (IVC1) of the intake valves is set to the vicinity of the bottom dead center on an end side of an intake stroke. As a result, a backward discharge in which the air or a mixture sucked at the restart flows backward to the intake port 014 side upon the transition to the compression stroke can be suppressed. Thus, a fresh air charging efficiency can be increased so as to further increase the combustion torque. A detailed description is later given of this control.

Then, upon the start of the engine, in other words, when the ignition switch is operated to be turned on, and the crankshaft is cranked for rotation by the drive motor 09 or the like, the control signal is output from the controller 22 to the electromagnetic switching valve 47. However, immediately after the start of the cranking, the discharged hydraulic pressure of the oil pump 49 has not sufficiently increased, and the vane member 32 is thus held to the most advanced side by the lock mechanism and the spring forces of the respective coil springs 55 and 56.

On this occasion, in response to the control signal output by the controller 22, the electromagnetic switching valve 47 brings the supply passage 45 and the first hydraulic passage 43 into communication, and brings the drain passage 46 and the second hydraulic passage 44 into communication. Then, as the cranking continues, the hydraulic pressure pressure-fed from the oil pump 49 increases, and is supplied to the advanced-side hydraulic chambers 41 via the first hydraulic passage 43. However, the hydraulic pressure is not fed to the retarded-side hydraulic chambers 42 as in the engine stop state. The hydraulic pressure is released from the drain passage 46 into the oil pan 48, and the retard side hydraulic chambers 42 maintain the low pressure state.

On this occasion, after the cranking rotation increases, and the hydraulic pressure further increases, vane position control by the electromagnetic switching valve 47 becomes available. In other words, as the hydraulic pressure increases in the advanced-side hydraulic chambers 41, the hydraulic pressure in the engagement hole 52a of the lock mechanism also increases, the lock pin 51 moves backward, and the tip portion 51a is disengaged from the engagement hole 52a so as to allow the relative rotation of the vane member 32 with respect to the housing 34. The vane position control thus becomes available.

For example, the electromagnetic switching valve 47 is activated by the control signal from the controller 22 so as to bring the supply passage 45 and the second hydraulic passage 44 into communication, and to bring the drain passage 46 and the first hydraulic passage 43 into communication. Thus, the hydraulic pressure in the advanced-side hydraulic chambers 41 is returned to the oil pan 48 via the first hydraulic passage 43 and then the drain passage 46. Thus, the pressure in the advanced-side hydraulic chambers 41 decreases. On the other hand, the hydraulic pressure is supplied into the retarded-side hydraulic chambers 42, and the pressure increases.

Thus, as a result of this increase in pressure in the retarded-side hydraulic chambers 42, the vane member 32 rotates in the counterclockwise direction of the drawing against the spring forces of the coil springs 55 and 56, relatively rotates toward a position illustrated in FIG. 6B, and converts a relative rotation phase of the drive shaft 6 with respect to the timing sprocket 31B toward the retarded side. Moreover, the drive shaft 6 can be held at an arbitrary relative rotation phase by bringing the position of the electromagnetic switching valve 47 to a neutral position in the course of the conversion. Further, the relative rotation phase can be continuously changed from the largest advancement (FIG. 6A) to the largest retardation (FIG. 6B) depending on the engine operation state after the start.

Moreover, the exhaust VTC 2 used for an embodiment described later is basically of the same vane type as the intake VTC 3 used in this embodiment. A brief description is now given of the exhaust VTC 2. The exhaust VTC 2 includes a timing sprocket, which is arranged on an end of the exhaust cam shaft and to which the rotational driving force is transmitted from the crankshaft 07, a vane member received inside the timing sprocket in a freely rotatable manner, and a hydraulic circuit for rotating forward and backward the vane member by means of a hydraulic pressure. It should be noted that the exhaust VTC 2 exhibits a retardation default, and a coil spring for biasing vanes is configured to bias the vanes in the retardation direction. It should be noted that the hydraulic circuit and the electromagnetic switching valve are basically the same as those for the intake VTC 3. A valve body inside the electromagnetic switching valve is configured to control relative switching between each hydraulic passage and a supply passage or a drain passage, and is activated for the switching by the control signal from the same controller 22. It should be noted that the exhaust VTC 2 exhibits the retardation default, and the electromagnetic switching valve thus has a reversed arrangement in the left/right direction of the three positions of the electromagnetic switching valve of FIG. 7 described above.

### First Embodiment

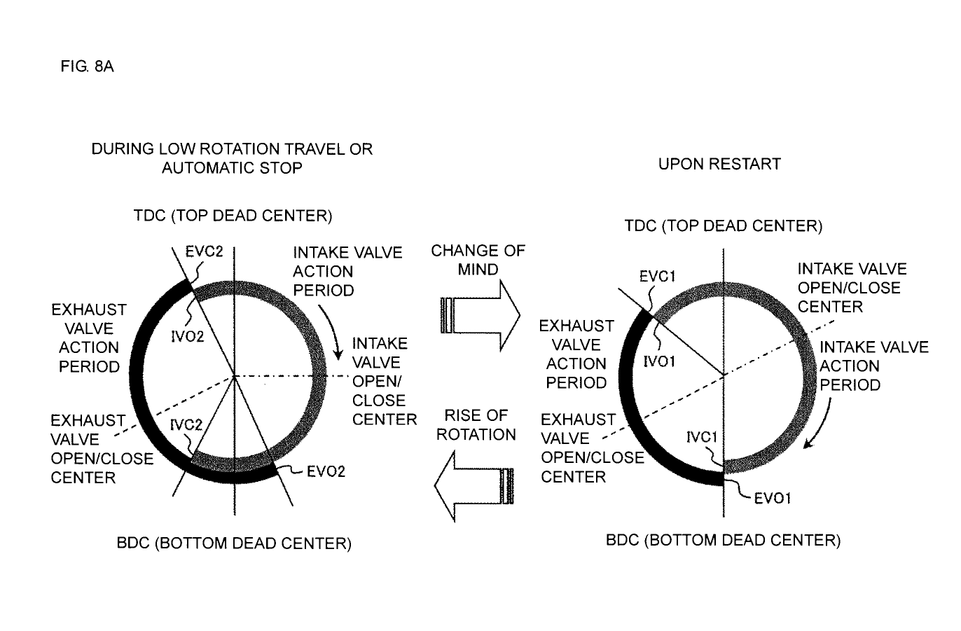

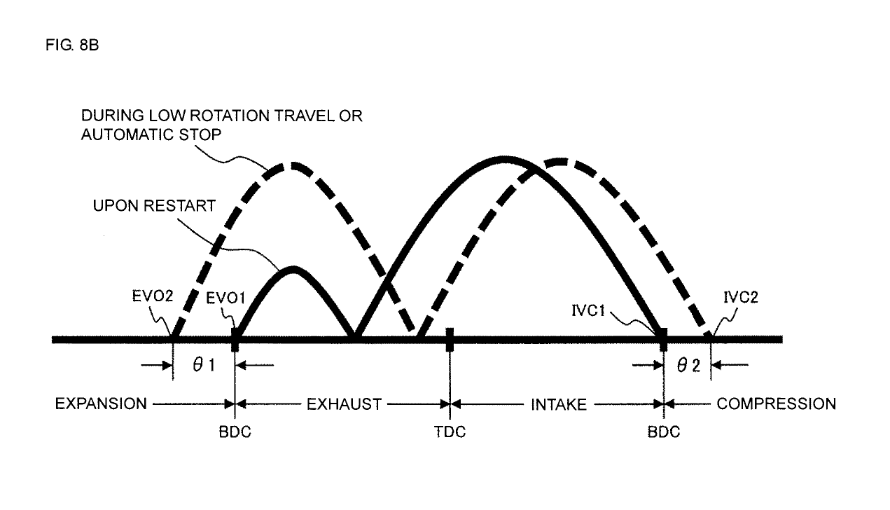

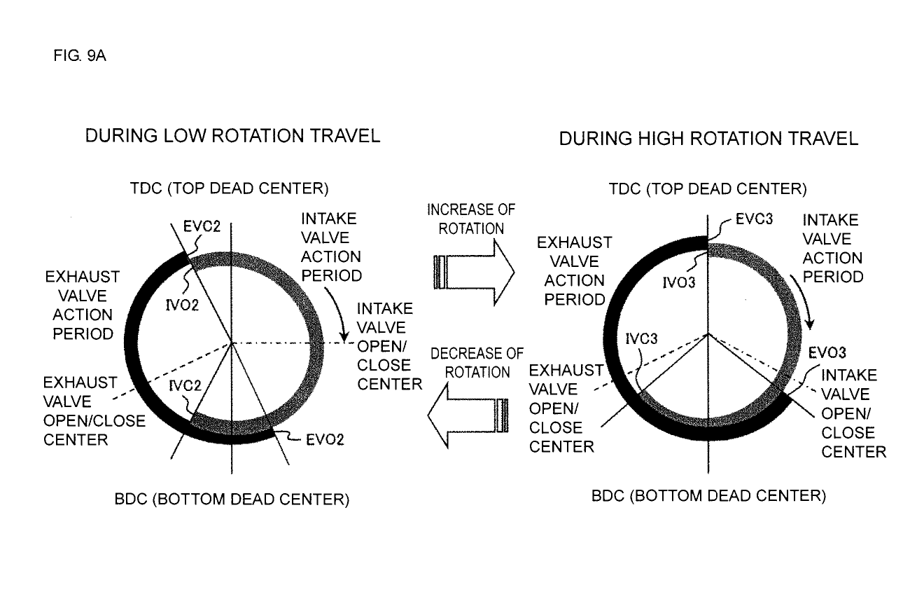

Referring to FIGS. 8A to 11, a detailed description is now given of a first embodiment of the present invention in an internal combustion engine including the variable valve actuating apparatus as described above. On this occasion, in the embodiment described below, the open timing (EVO1) of the exhaust valves 5 and the close timing (IVC1) of the intake valves 4 upon the restart are both default positions, and are the mechanically stable positions.

FIGS. 8A and 8B represent behaviors of the exhaust valves 5 and the intake valves 4 while the automatic stop state (upon the fuel injection stop) transitions to the restart state according to this embodiment. On this occasion, the exhaust valves 5 are controlled by the exhaust VEL 1, and the intake valves 4 are controlled by the intake VTC 3.

A left diagram of FIG. 8A illustrates an example of the open/close states of the exhaust valves 5 and the intake valves 4 in a low rotation travel state before a transition to the automatic stop state, or during the automatic stop (stop of the fuel injection) after a transition from this travel state to the automatic stop state of the vehicle. Moreover, a valve characteristic represented by the broken line of FIG. 8B corresponds to the open/close states of the exhaust valves 5 and the intake valves 4 on the left side of FIG. 8A. The open timing of the exhaust valves 5 is set to a general exhaust valve open timing (EVO2) advanced by a predetermined angle from the bottom dead center (BDC) on the expansion stroke end side, and the exhaust valves 5 start to open at the open timing (EVO2) in the second half of the expansion stroke, and exhaust the exhaust gas in the exhaust stroke.

The close timing of the exhaust valves 5 is set to a close timing (EVC2) advanced by a predetermined angle from the top dead center (TDC) on the exhaust stroke end side, and the exhaust valves 5 are closed before the top dead center (TDC) on the exhaust stroke end side. On this occasion, an exhaust valve open/close center represents an angle where the lift of the exhaust valves 5 is maximum.

On the other hand, an open timing (IVO2) of the intake valves 4 is set to a timing approximately the same as the close timing (EVC2) of the exhaust valves 5, and is advanced by a predetermined angle from the top dead center (TDC) on the intake stroke start side. Thus, the intake valves 4 start to open at the open timing (IVO2) in the second half of the exhaust stroke, and suck the fresh air in the intake stroke. Then, the close timing of the intake valves 4 is set to a general intake valve close timing (IVC2) retarded by a predetermined angle from the bottom dead center (BDC) on the intake stroke end side, and the intake valves are opened after the transition to the compression stroke.

When the vehicle is traveling at these intake/exhaust valve timings, and, for example, the driver recognizes a red signal, the driver releases an accelerator pedal, or further depresses a brake pedal. When the operations corresponding to the deceleration request are carried out, an engine automatic stop process (sequence) starts. Thus, the fuel is cut, and the number of engine revolutions decreases.

Then, when a restart request, which is a re-acceleration request caused by the above-mentioned “change of mind”, is generated in a course of the decrease in the rotational speed from this state, as illustrated in the diagram on the right side of FIG. 8A, the open/close states of the exhaust valves 5 and the intake valves 4 are changed. Moreover, a valve characteristic represented by the solid line of FIG. 8B corresponds to the open/close states of the exhaust valves 5 and the intake valves 4 on the right side of FIG. 8A.

Then, when the restart request caused by “change of mind” is generated, the open timing of the exhaust valves 5 is changed to the open timing (EVO1) in the vicinity of the bottom dead center (BDC) on the expansion stroke end side. In other words, the open timing of the exhaust valves 5 is retarded by θ1 from the open timing (EVO2) to the open timing (EVO1). In this case, the electric motor 20 of the exhaust VEL 1 is controlled to rotate in one direction so as to convert the timing to the mechanical stable position (default), which is the minimum lift (minimum operation angle). As a result, as shown in FIG. 5, the open timing (EVO1) of the exhaust valves 5 is set to the vicinity of the bottom dead center on the expansion stroke end side. The exhaust valves 5 start to open at the open timing (EVO1) from this state, and exhaust the exhaust gas in the exhaust stroke. Then, the close timing of the exhaust valves 5 is set to a close timing (EVC1) advanced by a predetermined angle from the top dead center (TDC) on the exhaust stroke end side. On this occasion, the close timing (EVC1) is further advanced from the close timing (EVC2) during the automatic stop (fuel injection stop), and the exhaust valves 5 are closed before the top dead center (TDC) on the exhaust stroke end side. On this occasion, the exhaust valves 5 are controlled by the exhaust VEL 1, and the lift characteristic is thus smaller than the lift characteristic during the automatic stop.

On the other hand, when the restart request is generated, the timing of the intake valves 4 is also converted to be advanced. An open timing (IVO1) on this occasion is set to a timing approximately the same as the close timing (EVC1) of the exhaust valves 5, and is advanced by a predetermined angle from the top dead center (TDC) on the intake stroke start side. Thus, the open timing (IVO1) for the restart is advanced from the open timing (IVO2) during the automatic stop, and the intake valves 4 are opened before the top dead center (TDC) on the exhaust stroke end side. Thus, the intake valves 4 start to open at the open timing (IVO1) in the second half of the exhaust stroke, and suck the fresh air in the intake stroke. Then, the close timing of the intake valves 4 is set to the close timing (IVC1) in the vicinity of the bottom dead center (BDC) on the intake stroke end side. In this case, the intake VTC 3 is used, and the close timing of the intake valves 4 is thus advanced by θ2, which is the same amount as that for the open timing. Also in this case, the intake VTC 3 has the mechanical stable position (default) in the vicinity of the most advanced position. Thus, when the timing is converted toward the advanced side, in addition to the conversion energy by the hydraulic pressure, energy toward the mechanical stability is added. Thus, an excellent conversion responsiveness is obtained.

Further, when the restart has succeeded, and the number of revolutions of the internal combustion engine increases to reach a predetermined stable number of revolutions, the open/close states of the exhaust valves 5 and the intake valves 4 return from the restart state on the right side of FIG. 8A to a state approximately the same as the state of the automatic stop or the low rotation on the left side of FIG. 8A.

A description now returns to the scene of the restart. As illustrated in FIG. 8B, in response to the restart request, the open timing (EVO2) of the exhaust valves 5 during the automatic stop is retarded to the vicinity of the bottom dead center (BDC) on the expansion stroke end side, and is changed to the open timing (EVO1). As a result, residue of the combustion gas is maintained up to the vicinity of the bottom dead center BDC on the expansion stroke end side, and the expansion energy of the combustion gas can thus be continuously supplied to the piston for a long period. As a result, the combustion torque (combustion work) is secured, and the restart can be carried out without using the starter.

Moreover, when the restart request is generated, the close timing (IVC1) of the intake valves is set to the vicinity of the bottom dead center on the intake stroke end side. The backward discharge in which the air or the mixture sucked at the restart flows back to the intake port side upon the transition to the compression stroke can thus be suppressed. Thus, the fresh air charging efficiency can be increased, and a higher combustion torque can thus be generated. As a result, a reliable and smooth restart can be obtained.

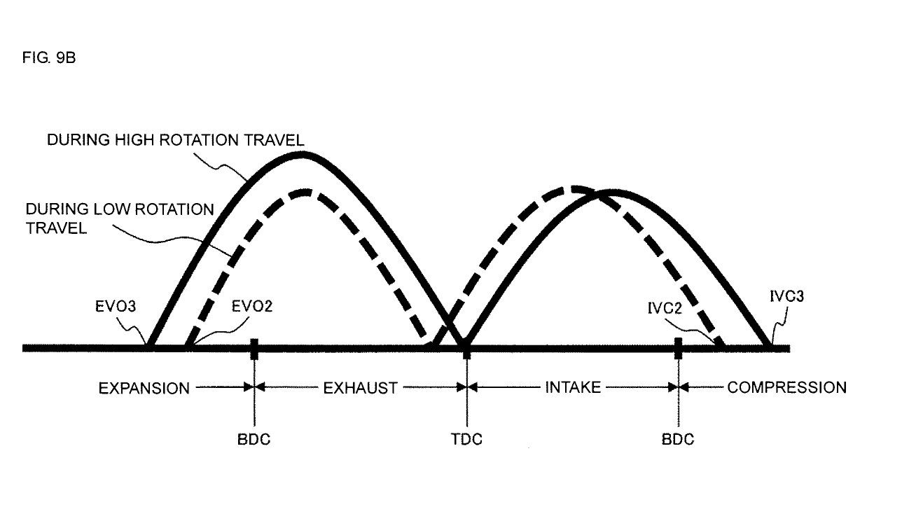

FIGS. 9A and 9B illustrate open/close states of the exhaust valves 5 and the intake valves 4 when the number of revolutions increases after the successful restart. A left side of FIG. 9A is approximately the same as the valve characteristic during the automatic stop or the low-rotation cruising before the transition to the automatic stop of FIG. 8A, and a valve characteristic represented by the broken line of FIG. 9B corresponds to the open/close states of the exhaust valves 5 and the intake valves 4 on the left side of FIG. 9A. Therefore, a description thereof is omitted.

Then, when the rotational speed increases from this state, as illustrated in the diagram on the right side of FIG. 9A, the open/close states of the exhaust valves 5 and the intake valves 4 change. A valve characteristic represented by the solid line of FIG. 9B corresponds to the open/close states of the exhaust valves 5 and the intake valves 4 on the right side of FIG. 9A. As the number of revolutions increases, the open timing of the exhaust valves 5 is changed to an open timing (EVO3) on a more advanced side from the open timing at the low rotation. In this case, the conversion electric power acts on the electric motor 20 of the exhaust VEL 1 so as to change the above-mentioned control shaft phase to a predetermined phase. As a result, as L3 of FIG. 5 represents, the predetermined lift state is brought about. The exhaust valves 5 start to open at the open timing (EVO3) from this state, and exhaust the exhaust gas in the exhaust stroke. Then, the close timing of the exhaust valves 5 is set to a close timing (EVC3) in the vicinity of the top dead center (TDC) on the exhaust stroke end side. On this occasion, the exhaust valves 5 are controlled by the exhaust VEL 1, and the lift characteristic is thus larger than the lift characteristic during the low rotation.

On the other hand, an open timing (IVO3) of the intake valves 4 is set to a timing approximately the same as the close timing (EVC3) of the exhaust valves 5, and is set to the vicinity of the top dead center (TDC) on the intake stroke start side. Thus, the open timing (IVO3) for the high rotation is retarded from the open timing (IVO2) for the low rotation, and the intake valves 4 are opened at the top dead center (TDC) on the intake stroke start side. Thus, the intake valves 4 start to open at the open timing (IVO3) at the beginning of the intake stroke, and suck the fresh air in the intake stroke. Then, the close timing of the intake valves 4 is set to a close timing (IVC3) retarded from the bottom dead center (BDC) on the intake stroke end side. In this case, the intake VTC 3 is used, and the close timing of the intake valves 4 is retarded by the same amount as that for the open timing. Also in this case, the intake VTC 3 is in the control state, and hence the valve timing appropriate for the operation state is selected.

Further, when the number of revolutions of the internal combustion engine increases and then returns to the low rotation state, the open/close states of the exhaust valves 5 and the intake valves 4 return from the high rotation state on the right side of FIG. 9A to the low rotation state on the left side of FIG. 9A.

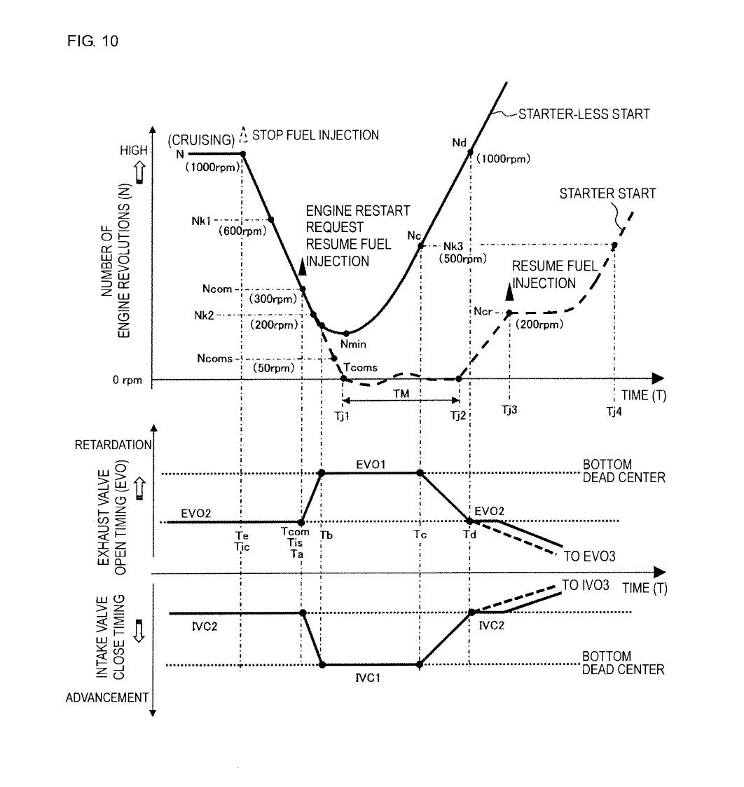

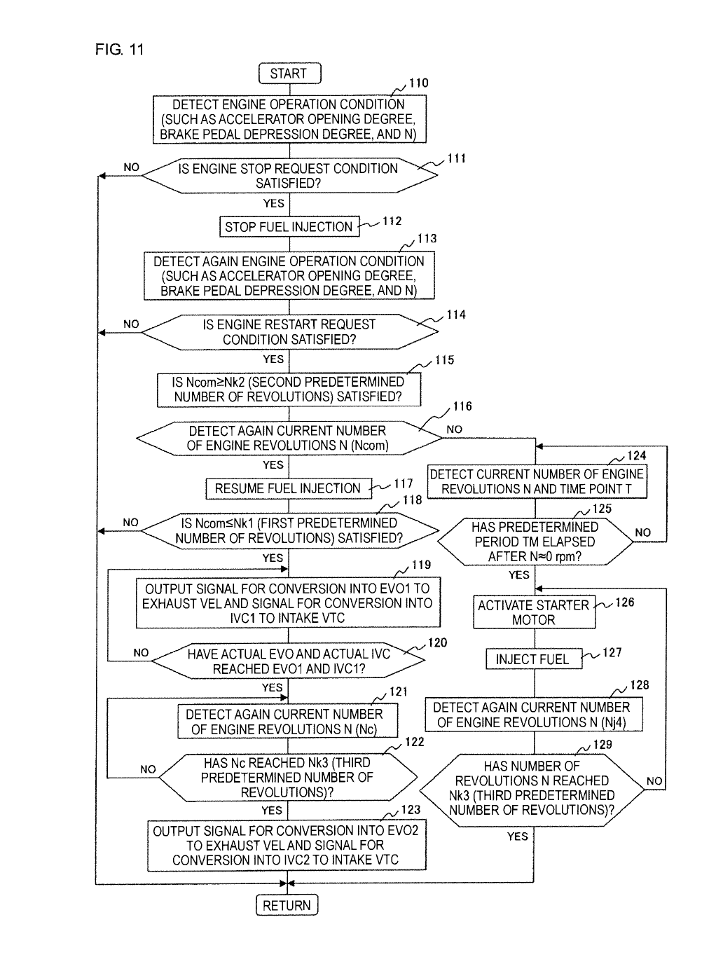

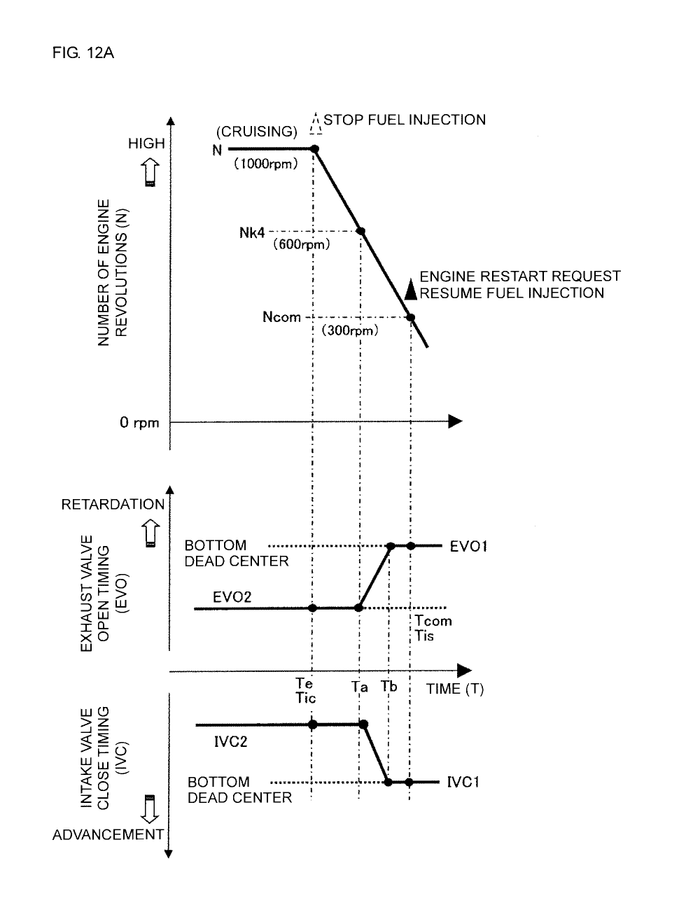

Referring to FIGS. 10 and 11, a description is now given of a change in the number of revolutions and changes in the close timing of the intake valves 4 and the open timing of the exhaust valves 5 and of a specific control flow for carrying out the changes, when the travel state transitions to the automatic stop (fuel injection stop) state, and when the restart is further carried out thereafter based on “change of mind.” On this occasion, the control flow illustrated in FIG. 11 is activated at an interruption timing that arrives after every predetermined period.

In FIG. 10, it is assumed that the vehicle is now in the travel state (for example, cruising), and the number of revolutions N of the internal combustion engine is, for example, 1,000 rpm. Then, when the engine stop request (vehicle deceleration request) is generated at a time point Te, the fuel injection is stopped, in other words, the engine automatic stop process (sequence) starts at a time point Tic approximately in synchronous with the generation of the engine stop request, and the number of revolutions N starts to decrease. This engine stop request mainly corresponds to the request (operation) of the driver. When the driver releases the accelerator pedal, a relatively gentle deceleration characteristic of the number of engine revolutions N is presented as a result of the fuel injection stop. When the driver further depresses the brake pedal, a relatively rapid decrease characteristic of the number of revolutions N is presented. Moreover, this decrease characteristic of the number of revolutions N changes also depending on presence/absence of a road gradient. Further, also when the connection between the internal combustion engine and the axle is released by power train control such as control of disengaging a lockup clutch, the number of revolutions N presents a relatively rapid decrease characteristic. In any case, the number of revolutions N starts decreasing from the vicinity of the time point Tic when the fuel injection is stopped.

Referring to the corresponding flowchart illustrated in FIG. 11, in Step 110, the operation state of the internal combustion engine is detected, and, in Step 111, whether or not the engine stop request (the vehicle deceleration request is output at the time point Te) is output is determined based on the release (opening degree) of the accelerator pedal, a brake depression amount (depression degree), and the like. In Step 111, when the engine stop request is determined to be generated, the processing proceeds to Step 112, to thereby stop the fuel injection at the time point Tic approximately in synchronous with the time point Te. Thereafter, the fuel is not supplied, and hence, as illustrated in FIG. 10, the number of revolutions N of the internal combustion engine decreases. It should be noted that when, in Step 111, the engine stop request is determined not to be generated, the processing proceeds to return, to thereby wait for the next activation timing.

A description now returns to the above-mentioned state of the decreasing number of engine revolutions. On this occasion, the power train control may hold the lockup clutch engagement state, or may release the engagement. In the first case, the clutch is already engaged. Therefore, there is such an advantage in that, when the acceleration is immediately carried out again thereafter, a re-acceleration responsiveness is excellent. On the other hand, in the second case, for example, there are such an advantage in that the engine braking by the internal combustion engine can be decreased, and regeneration brake electric power by an alternator and the like can be increased accordingly, and such an advantage in that an engine load upon the engine restart can be reduced.

A description now returns to FIG. 10. In the course of the decrease in the number of revolutions N as a result of the stop of the fuel injection, the state in which the re-acceleration request, namely, “change of mind”, which is the engine restart request for the internal combustion engine, is output from the driver may occur. This corresponds to the following case. For example, when the driver releases the accelerator pedal or depresses the brake pedal in a state in which an intersection signal is “red”, the fuel injection is stopped, and the rotational speed of the internal combustion engine decreases. When the state of the intersection signal transitions from “red” to “green” in the course of the decrease, the driver depresses the accelerator pedal again or switches from the depression on the brake pedal to the depression on the accelerator pedal.

Then, in the flowchart, in the course of the decrease in the number of engine revolutions N, in Step 113, the operation state in which “change of mind” is output is detected. Then, the processing proceeds to Step 114, and whether or not the restart request condition, which is “change of mind” (COM) of the driver, is satisfied is determined based on an increasing change in the depression amount of the accelerator pedal. When the restart condition is determined not to be satisfied, the processing proceeds to return, to thereby wait for the next activation timing. On the other hand, when the restart condition is determined to be satisfied, a current number of revolutions Ncom is detected in Step 115, and the processing proceeds to Step 116, to thereby determine whether or not the detected number of revolutions Ncom is equal to or more than a second predetermined number of revolutions Nk2 close to 0 rpm. The second predetermined number of revolutions Nk2 is a threshold of the number of revolutions for determining whether or not the starter-less start is possible.

In Step 116, when the detected number of revolutions Ncom (such as 300 rpm) is equal to or more than the second predetermined number of revolutions Nk2 (such as 200 rpm), the starter-less start is determined to be possible by the fuel injection without using the starter, and the processing transitions to a restart sequence by means of the starter-less start. On the other hand, when the detected number of revolutions Ncom is determined to be less than the second predetermined number of revolutions Nk2, a reliable restart is determined not to be possible without using the starter, and the processing transitions to a restart sequence using the starter.

In Step 116, when the number of revolutions Ncom upon the restart request is equal to or more than the second predetermined number of revolutions Nk2, the processing proceeds to Step 117, and the fuel injection is immediately resumed at a time point Tis. After the fuel injection is carried out, in Step 118, when the number of revolutions Ncom detected in Step 115 is more than a first predetermined number of revolutions Nk1 (such as 600 rpm) set to be higher than the second predetermined number of revolutions Nk2, the starter-less start is possible even at the current valve timings at the automatic stop, and hence the processing directly proceeds to return. Thus, the starter-less restart is carried out still in the open/close states of the intake valves 4 and the exhaust valves 5 illustrated on the left side of FIG. 8A.

The first predetermined number of revolutions Nk1 is a threshold of the number of revolutions for determining whether the open/close states of the intake valves 4 and the exhaust valves 5 at the automatic stop illustrated on the left side of FIG. 8A are continuously used, or the open/close states of the intake valves 4 and the exhaust valves 5 for the restart illustrated on the right side of FIG. 8A are used.

On the other hand, in Step 118, when the number of revolutions Ncom detected in Step 115 is equal to or less than the first predetermined number of revolutions Nk1, in order to increase a start certainty of the starter-less start, the processing proceeds to Step 119, to thereby immediately output the control signals to the exhaust VEL 1 and the intake VTC 3 at a time point Ta so that the open/close states of the intake valves 4 and the exhaust valves 5 represented on the right side of FIG. 8A are attained.

In other words, in order to increase starter-less start capability, the exhaust valve open timing is changed from the open valve timing (EVO2) at the automatic stop to the open valve timing (EVO1) in the vicinity of the bottom dead center on the expansion stroke end side. On this occasion, the return force of the coil spring 30 of the exhaust VEL 1 is additionally used as the conversion energy. Thus, the timing quickly transitions from the open timing (EVO2) to the open timing (EVO1) at a large time gradient, namely, at a high conversion responsiveness.

Further, the intake valve close timing is changed from the close timing (IVC2) at the automatic stop to the close timing (IVC1) in the vicinity of the bottom dead center on the intake stroke end side. Also in this case, the return force of the coil spring 55 (56) of the intake VTC 3 is additionally used as the conversion energy. Thus, the timing quickly transitions from the close timing (IVC2) to the close timing (IVC1) at a large time gradient, namely, at a high conversion responsiveness.

On this occasion, the time elapses through the time points Tcom, Tis, and Ta, which are arranged in the sequence of the above-mentioned control steps, but a period of calculation carried out by a microcomputer is negligible compared with the operation periods of the internal combustion engine and the control mechanisms. Thus, the time points can be considered to be approximately synchronized with one another.

An operation angle decrease control signal is output to the exhaust VEL 1, and an advancement control signal is output to the intake VTC 3 at the time point Ta approximately synchronized with the time point Tcom for the restart request and the time point Tis for the fuel injection restart in this way. As a result, the operation angle D2 (exhaust valve open timing EVO2) for the traveling is converted into the minimum operation angle D1 (exhaust valve open timing EVO1) in the exhaust VEL 1. Moreover, the close timing of the intake valves by the intake VTC 2 is converted in association with this change. The intake valve open/close center by the intake VTC 3 is slightly retarded for the operation angle D2 of the exhaust VEL 1, but is maximally advanced in response to the change to the operation angle D1.

As a result, the valve open/close states of the intake valves 4 and the exhaust valves 5 are converted from the state illustrated on the left side of FIG. 8A into the state illustrated on the right side of FIG. 8A. It should be noted that, according to this embodiment, the energy of the biasing springs in addition to the electric energy and the hydraulic energy is used for the conversion control for the exhaust VEL 1 and the intake VTC 3, and the highly responsive conversion can thus be provided as described before. However, the control signals may be shut off, and the open timing (EVO1) of the exhaust valves 5 and the close timing (IVC1) of the intake valves 4 may be attained only by the energy of the biasing springs that mechanically stabilize the states into the default states. In this case, the conversion responsiveness may degrade, but the electric energy and the hydraulic energy do not need to be used, and a fuel economy performance increases.

On this occasion, the open timing of the exhaust valves 5 for the restart according to this embodiment is retarded to the vicinity of the bottom dead center on the expansion stroke end side. As a result, a remarkable effect can be obtained in the starter-less start at an extremely low rotation, and a supplementary description is now given thereof.

In the internal combustion engine, the combustion pressure by the combustion gas carries out combustion work of pressing down the piston, and, as a result, the combustion torque of rotating the crankshaft is generated. Then, when the exhaust valves 5 are opened in the expansion stroke before the piston reaches the bottom dead center, this combustion pressure is released to an exhaust pipe side, and is thus not effectively used as the energy of pressing down the piston. However, the exhaust valve open timing (EVO) of the general internal combustion engine is generally set to a timing somewhat before the bottom dead center, in other words, on the advanced side. The number of engine revolutions is relatively high in a normal combustion operation state. Thus, choking (flow rate choking effect) is caused in an extremely small lift area at a beginning of the lift on the exhaust valves 5, and a combustion gas is less liable to be exhausted to the exhaust pipe side. As a result, even when the open timing of the exhaust valves 5 is set to the advanced side, influence on the decrease in the combustion work is relatively small.

Moreover, when the number of revolutions is high, and the open timing of the exhaust valves 5 is not somewhat advanced, an exhaust gas pushing out loss increases, and such a problem as a decrease in the torque or the degradation of the fuel economy is caused. For these reasons, the open timing of the exhaust valves 5 is generally advanced by a predetermined angle with respect to the bottom dead center on the expansion stroke end side in the normal operation.

In contrast, for the special case of the starter-less start in which the restart is carried out by the combustion energy of the fuel without using the starter, it is found that the open timing of the exhaust valves 5 is advantageously further retarded to the vicinity of the bottom dead center on the expansion stroke end side. In other words, a combustion gas amount itself per unit time is small at the extremely low number of revolutions, and a flow-out speed of the exhaust gas is thus low even in the extremely small lift area at the beginning of the lift of the exhaust valves 5. Therefore, the choking (flow rate choking effect) is less liable to occur, and the combustion gas tends to pass through the cylinder to the exhaust pipe side accordingly. As a result, such a phenomenon that the combustion pressure decreases early is caused, and the combustion energy is not sufficiently used.

In contrast, the pass-through of the combustion gas can be suppressed by further retarding the open timing of the exhaust valves 5 to the vicinity of the bottom dead center on the expansion stroke end side according to this embodiment. As a result, the combustion work by the combustion gas pushing down the piston can be increased, and the combustion torque can be increased in the starter-less start. On this occasion, as a principle of increasing the combustion torque, a peak combustion pressure of the combustion gas is not excessively increased, but a period in which the combustion pressure is acting on the piston is increased. Thus, an adverse effect on a fluctuation in rotation of the engine caused by the excessive increase in the peak combustion pressure can be suppressed, and such a point that a degradation of the rotation fluctuation for which the occupants feel a sense of discomfort particularly upon the start can be suppressed is provided as an excellent feature. Moreover, in the starter-less start, during the decrease in the number of revolutions N, in order to prevent the number of revolutions N from decreasing and further increase the number of revolutions N, sufficient combustion work is necessary. For that purpose, as described above, the open timing of the exhaust valves 5 needs to be further retarded to the vicinity of the bottom dead center on the expansion stroke end side so as to sufficiently increase the combustion torque.

Further, when the lockup clutch is engaged when the starter-less start is carried out, the internal combustion engine needs to accelerate for the weight of the vehicle, and even a larger combustion work is thus necessary. When it is assumed that the open timing of the exhaust valves 5 is excessively retarded beyond the bottom dead center on the expansion stroke end side, and the piston passes the bottom dead center and turns to move upward, the upward action is suppressed by the remaining combustion pressure of the combustion gas, and the combustion pressure is used to decrease the number of revolutions of the internal combustion engine, which is an adverse effect. Therefore, the open timing of the exhaust valves set to the vicinity of the bottom dead center on the expansion stroke end side as in this embodiment is considered as the optimal open timing of the exhaust valves 5.

Further, according to this embodiment, the close timing (IVC1) of the intake valves 4 is also set to the vicinity of the bottom dead center on the intake stroke end side. As a result, special effects described below can be obtained at the extremely low rotation.

In a case where a close timing of the intake valves is retarded by a predetermined angle from the bottom dead center on the intake stroke end side, when the stroke transitions to the compression stroke, at the extremely low rotation, the fresh air once taken into the combustion chamber tends to be discharged backward to the intake port side. At the extremely low rotation, even a slight lift in an area at an end of the lift of the intake valves decreases the flow rate of the fresh air passing through the intake valves. Thus, the choking (flow rate choking effect) is less liable to be caused, and, consequently, the fresh air in the combustion chamber tends to be easily discharged backward to the intake port side, resulting in a decrease in the fresh air charging efficiency. Therefore, a sufficient combustion torque is not obtained, and a fear of obstructing a smooth starter-less start is thus conceivable.

Thus, according to this embodiment, when the number of revolutions of the internal combustion engine is extremely low, the backward discharge of the fresh air is suppressed by sufficiently advancing the open timing (IVC1) of the intake valves 4 to the vicinity of the bottom dead center on the intake stroke end side. As a result, the fresh air charging efficiency in the combustion chamber is controlled to increase at the extremely low rotation, and the combustion torque of the starter-less start can be further increased in addition to the combustion torque increase effect by setting the open timing (EVO1) of the exhaust valves to the vicinity of the bottom dead center as described above. When it is assumed a case where the close timing of the intake valves 4 is further advanced beyond the bottom dead center of the intake stroke end side, an intake stroke by the piston decreases, and, conversely, there is a fear of a decrease in the charging efficiency. Thus, the close timing of the intake valves 4 is optimally set to the vicinity of the bottom dead center on the intake stroke end side as in this embodiment.

Then, in Step 120, whether or not the exhaust valves 5 reach the open timing (EVO1) in the vicinity of the bottom dead center on the expansion stroke end side, and whether or not the intake valves 4 reach the close timing (IVC1) in the vicinity of the bottom dead center on the intake stroke end side are determined. When this condition is not satisfied, the processing returns to Step 119, and, otherwise, the processing proceeds to Step 121. In Step 120, after the time point Tb when the exhaust valves 5 have reached the open timing (EVO1) and the intake valves 4 have reached the close timing (IVC1), as a result of the effect of the increase in the combustion torque (combustion work) described above, the decrease in the number of revolutions N begins to slow down, and the number of revolutions N turns to increase after reaching a minimum number of revolutions Nmin.

The processing in Step 119 causes the increase in the number of revolutions N, and when the lockup clutch has been disengaged, the lockup clutch is engaged again in the vicinity of an area exceeding the extremely low rotation area. Then, the number of revolutions N further increases. On this occasion, the current number of revolutions is detected in Step 121, and, further in Step 122, when the number of revolutions Nc detected at a time point Tc is determined to have reached a third predetermined number of revolutions Nk3 (such as 500 rpm), the processing proceeds to Step 123. Then, a conversion signal is output so that the open timing of the exhaust valves 5 is again set to the open timing (EVO2) advanced by the predetermined angle from the bottom dead center (BDC) on the expansion stroke end side. Further, a conversion signal is output so that the close timing of the intake valves 4 is set to the close timing (IVC2) retarded by the predetermined angle from the bottom dead center (BDC) on the intake stroke end side.

Actually, the open timing (EVO2) and the close timing (IVC2) are set to be reached at a time point Td based on a control calculation cycle, a gain of the control signals, and the like, and a period to reach the time point Td is adjustable. Then, the start is considered as being succeeded at this time point, and the restart control is thus finished. The number of revolutions N at this time point is increased to approximately 1,000 rpm at this time, and thus there is no fear of a stop of the engine. A reason for carrying out this valve timing return control is that, when the starter-less start has succeeded and the number of revolutions N has further increased, if the valve timing for the starter-less start is maintained, the torque is insufficient, and a sufficient acceleration characteristic cannot be acquired. Thus, the open timing of the exhaust valves 5 is changed to the open timing (EVO2) early, and, similarly, the close timing of the intake valves 4 is changed to the close timing (IVC2). Thus, at the time point Td, at the vicinity of the idling number of revolutions or the number of engine revolutions Nd (such as 1,000 rpm) slightly higher than the idling number of revolutions, the open timing (EVO2) of the exhaust valves 5 and the close timing (IVC2) of the intake valves 4 are reached. When the above-mentioned control is carried out, the starter-less start has been successfully finished, and the control transitions to normal control based on an operation map. In this case, when the number of revolutions N further increases, the control illustrated in FIG. 9A is carried out. When the rotational speed increases from the control states for the exhaust valves 5 and the intake valves 4 on the left side of FIG. 9A, the open/close states of the exhaust valves 5 and the intake valves 4 change as illustrated on the right side of FIG. 9A, and the open timing (EVO3) of the exhaust valves 5 and the close timing (IVC3) of the intake valves 4 are reached.

It should be noted that the exhaust valves 5 according to this embodiment have valve lift characteristics as shown in FIG. 5, and hence the open timing (EVO3) of the exhaust valves 5 advances in response to an increase in the number of revolutions, thereby decreasing the pushing out loss caused by the increase in the rotation. Moreover, as illustrated in the right diagram of FIG. 9A, the close timing (IVC3) of the intake valves 4 is set to the retarded side, and the charging efficiency upon the increase in the rotation thus increases, resulting in an increase in the torque upon the increase in the rotation. Further, when the number of revolutions increases to the vicinity of the maximum rotation, an open timing (EVO4) of the exhaust valves 5 is on the maximally advanced side, and the pushing out loss is reduced at the maximum number of revolutions. Moreover, similarly, a close timing (IVC4) of the intake valves 4 is on the retarded side. Thus, the charging efficiency at the maximum number of revolutions can be increased, and the torque and the maximum output in the vicinity of the maximum internal combustion engine rotation can be increased.

On this occasion, the process from the open timing (EVO2) of the exhaust valves 5 and the close timing (IVC2) of the intake valves 4 to the open timing (EVO3) of the exhaust valves 5 and the close timing (IVC3) of the intake valves 4 may be controlled so that, as the solid lines represent, the timings maintain the open timing (EVO2) of the exhaust valves 5 and the close timing (IVC2) of the intake valves 4 in a predetermined revolution number range, and, then, reach the open timing (EVO3) of the exhaust valves 5 and the close timing (IVC3) of the intake valves 4, or may be controlled so that, as the broken lines represent, the timings gradually reach the open timing (EVO3) of the exhaust valves 5 and the close timing (IVC3) of the intake valves 4.

Now, a case where a related-art starter start is carried out instead of the starter-less start is assumed. The number of engine revolutions Ncom at the time point Tcom upon the restart request is higher than a normal number of cranking revolutions caused by the starter. When the current is forcedly supplied to the starter, a load increases due to a forceful meshing, resulting in degradation of durability, and generation of noises. Moreover, whether the lockup clutch is engaged or disengaged at the time point Tcom, this problem occurs. Therefore, the current is not immediately supplied to the starter at the time point Tcom, and, as indicated by the broken line (starter start) of FIG. 10, the start by the starter is required to be started after a stable state is reached after the number of revolutions N decreases to the vicinity of 0 rpm under a state in which the lockup clutch is disengaged. On this occasion, the crankshaft may rotate backward before the stable state is reached, and a period as long as one second may be necessary. As a result, the restart (re-acceleration) is delayed, and the re-acceleration request from the driver may not be satisfied.

In contrast, according to this embodiment, when the restart request is generated after the stop of the fuel injection, and the restart is carried out, the combustion torque acquired by the combustion energy of the fuel can be effectively used. As a result, the high acceleration performance is acquired by the starter-less start (combustion start), and the lower limit rotational speed permitting the starter-less start can be decreased so as to increase the ratio of the starter-less start, namely, the frequency, the number of times, and the like of the starter-less start. Moreover, the fresh air is not discharged backward to the intake system in the compression stroke. Thus, a higher combustion torque is generated, and a reliable and smooth starter-less start can be obtained.

As described above, according to this embodiment, the ratio of the starter-less start can be increased, which means a decrease in a ratio of the starter start and the number of times of the activation of the starter. Thus, it should be understood that the decrease in the durability of the starter, which is suspected in the start-stop system, can be suppressed.

Referring back to FIG. 11, in Step 116, when the number of revolutions Ncom at the time point Tcom is less than the second predetermined number of revolutions Nk2, the processing transitions to the starter start even in this embodiment. FIG. 10 illustrates the number of revolutions Ncoms (such as 50 rpm) and a time point Tcoms at this time point upon the engine restart request. When the number of revolutions Ncoms upon the engine restart request is low, even the above-mentioned control cannot suppress the decrease in the number of revolutions N, and the subsequent minimum number of revolutions Nmin may reach 0 rpm. This means that the basic cycle (intake-compression-expansion-exhaust) of the internal combustion engine does not active, and the internal combustion engine stops, resulting in a possibility of a failure of the starter-less start.

Thus, in Step 116, when the number of revolutions Ncoms upon the restart request is less than the second predetermined number of revolutions Nk2, the processing proceeds to Step 124 for the transition to the normal starter start. In other words, the fuel is not injected again at the time point Tcoms corresponding to the number of revolutions Ncoms, and the start using the starter is prepared. In Step 124, the current number of revolutions N and the time point on this occasion are detected by using a timer. Then, when the internal combustion engine and the axle are connected with each other immediately before a time point Tj1 at which the number of revolutions decreases to the vicinity of 0 rpm, the lockup clutch of the transmission is disengaged, or a shift to a neutral gear is carried out so as to disconnect the internal combustion engine and the axle from each other. Then, in Step 125, whether or not a predetermined period TM has elapsed from the time point Tj1 is determined. When the predetermined period TM has not elapsed, the processing returns to Step 124. When the predetermined period TM has elapsed, and a time point Tj2 is reached, in Step 126, a current is supplied to the starter so as to start the starter operation. On this occasion, the elapse of the predetermined period TM is determined so that a time interval is secured until an unstable phenomenon such as a backward rotation phenomenon after the number of revolutions reaches the vicinity of 0 rpm does not occur for securing a stable starter start.

Then, when the internal combustion engine is forced to rotate by the starter, in Step 127, the fuel injection is restarted in the vicinity of a time point Tj3 at which the number of revolutions N reaches a cranking set number of revolutions Ncr. The combustion starts as a result of this fuel injection so as to cause the complete combustion. Thus, the number of revolutions N increases, and the internal combustion engine and the axle are again connected with each other. Then, in Step 128, a current number of revolutions Nj4 is detected again. The restart is determined to be succeeded at a time point Tj4 at which the number of revolutions Nj4 reaches the third predetermined number of revolutions Nk3, and the processing proceeds to return, thereby finishing the series of control. When the number of revolutions Nj4 does not reach the third predetermined number of revolutions Nk3, the processing again returns to Step 126, to thereby carry out the series of processing.

On this occasion, the cranking set number of revolutions Ncr for the starter start is an extremely low rotation of approximately 100 to 200 rpm, but the open timing of the exhaust valves 5 is set to the open timing (EVO2) as in the related-art case, and the close timing of the intake valves 4 is similarly set to the close timing (IVC2). In the state in which the open timing (EVO2) and the close timing (IVC2) are set, the combustion torque (work) is small, but the starter is used. Therefore, such a large combustion torque as in the starter-less start, which suppresses the decrease in the rotation and further turns the number of revolutions to increase, is not necessary. Thus, the starter start can be carried out in this state.

Moreover, in the starter-less start, the internal combustion engine and the axle may be connected with each other, and the vehicle itself may thus need to be accelerated. In contrast, in the case of the starter start, only the internal combustion engine rotates at the extremely low number of revolutions of approximately 100 to 200 rpm. In this case, the internal combustion engine and the axle are disconnected from each other, and the required combustion torque is also low. Thus, the starter start can thus be carried out. Thus, when the starter start is carried out, the open timing of the exhaust valves 5 can be set to the open timing (EVO2), and, similarly, the close timing of the intake valves 4 can be set to the close timing (IVC2) without problems.

On the other hand, the starter start is carried out as in the related art, and a period required until the restart thus extends, but an influence on the re-acceleration performance required by the driver is relatively small. In other words, the starter-less start is no longer carried out, and the re-acceleration performance thus decreases, but the internal combustion engine is also in the state immediately before the stop, and the decrease in the re-acceleration performance is not felt by the driver as a sense of discomfort. Further, such a phenomenon that the number of revolutions rapidly decreases to an extremely low number of revolutions is a case in which the driver applies a quick brake, or the like. Thus, the high re-acceleration performance immediately after the braking tends not to be required so much. Thus, the starter start similar to the related art does not cause many problems.

In general, when the accelerator pedal is released and then is depressed, a high acceleration is required. However, when the accelerator pedal is depressed after the braking, the driver depresses the brake pedal, moves the foot to the accelerator pedal, and then depresses the accelerator pedal. Therefore, the driver tends to permit a somewhat delay in the re-acceleration. Thus, the requested acceleration is also low, and when the number of revolutions N reaches an extremely low number of revolutions close to 0 rpm less than the second predetermined number of revolutions Nk2, the starter-less start may fail. Therefore, the start is switched to the reliable restart by using the starter. The restart by using the starter is the same as the normal starter start from the stop of the vehicle, and an operation reliability thereof is established. Thus, a fear of a decrease in the operation reliability of the starter start is small.

It should be noted that when the processing proceeds to Step S124 so as to transition to the normal starter start, a control signal for changing the open timing of the exhaust valves 5 to the open timing (EVO1), and a control signal for changing the close timing of the intake valves 4 to the close timing (IVC1) may be output. These valve timings are the default timings. Therefore, the spring force of the biasing springs is added, and, even at a rotation close to 0 rpm, the timings are converted into these valve timings in the predetermined period TM so as to increase the starter start capability. A description now returns to the scene of the starter-less start. According to this embodiment, when the combustion torque is sufficiently secured with a margin by the change in the open timing of the exhaust valves 5 upon the starter-less start, the control of changing the close timing of the intake valves 4 from the close timing (IVC2) to the close timing (IVC1) may be omitted, or an extent of the change may be decreased. In this case, the intake charging efficiency accordingly decreases. Thus, the peak combustion pressure decreases, and a rotation fluctuation in the starter-less start can be further decreased. Alternatively, the close timing may be changed to the close timing (IVC1), and a fuel reinjection amount may be reduced so as to reduce the combustion torque. In this case, an effect of increasing the fuel economy can be expected.

Moreover, the first predetermined number of revolutions (Nk1) is desirably decreased and set to the vicinity of the idling number of revolutions. The first predetermined number of revolutions (Nk1) is the lower limit number of revolutions of a range in which the combustion operation is carried out by the starter-less start at the normal close timing (IVC2) of the intake valves 4 and the normal open timing (EVO2) of the exhaust valves 5. Therefore, at the normal close timing (IVC2) of the intake valves 4 and the normal open timing (EVO2) of the exhaust valves 5, the combustion can be started by the starter-less start. Thus, the range of the starter-less start can be extended to the low rotation side without the control of changing the close timing of the intake valves 4 to the close timing (IVC1), and changing the open timing of the exhaust valves 5 to the open timing (EVO1).

Moreover, the second predetermined number of revolutions (Nk2) is desirably set to the number of revolutions in the vicinity of the cranking set number of revolutions Ncr or slightly less than the cranking set number of revolutions Ncr. This setting eliminates a rotation area in which the start is not possible (rotation area not included in any one of the following areas) between a rotation area equal to less than the cranking set number of revolutions Ncr in which starter start is possible and a rotation area equal to or more than the second predetermined number of revolutions (Nk2) in which the starter-less start is possible. As a result, the restart can be reliably carried out by means of any one of the starts, resulting in an effect of an increase in the quality of the start control.

Further, the third predetermined number of revolutions (Nk3) is the number of revolutions for starting conversions of the valve timings which have changed to EVO1 and IVC1 for the starter-less restart to EVO2 and IVC2 again, and only needs to be set to the number of revolutions in the vicinity of the idling number of revolutions or slightly less than the idling number of revolutions. According to this embodiment, the third predetermined number of revolutions (Nk3) is set to the number of revolutions between the first predetermined number of revolutions (Nk1) and the second predetermined number of revolutions (Nk2), and is close to the first predetermined number of revolutions (Nk1). As a result, the valve timings are changed to the normal close timing (IVC2) of the intake valves 4 and the normal open timing (EVO2) of the exhaust valves 5 at the idling number of revolutions or a rotation area slightly higher than the idling number of revolutions after the successful starter-less start, resulting in a smooth rise in the number of revolutions. Further, when the number of revolutions increases to the number of revolutions Nd beyond the third predetermined number of revolutions (Nk3), the open timing (EVO2) of the exhaust valves 5 and the close timing (IVC2) of the intake valves 4 are controlled to reach the open timing (EVO3) of the exhaust valves 5 and the close timing (IVC3) of the intake valves 4, resulting in a smooth increase in the number of revolutions N.

On this occasion, according to this embodiment, during the changes from the open timing (EVO2) of the exhaust valves 5 and the close timing (IVC2) of the intake valves 4 to the open timing (EVO1) of the exhaust valves 5 and the close timing (IVC1) of the intake valves 4, the valve overlap amount (section) is not practically changed, and a setting without the valve overlap amount is substantially provided. Thus, after the time point Tcom at which the engine restart request is generated, in the course of the changes from the open timing (EVO2) of the exhaust valves 5 and the close timing (IVC2) of the intake valves 4 to the open timing (EVO1) of the exhaust valves 5 and the close timing (IVC1) of the intake valves 4, such a phenomenon that the air (gas) on the exhaust port side is discharged toward the intake port side (caused in the valve overlap section) is stabilized, and the amount of the air (gas) itself can be suppressed. Thus, the air-fuel ratio can be stabilized so as to further stabilize the starter-less start.

It should be noted that, according to this embodiment, a description is mainly given of the restart capability for the case in which, under the vehicle travel condition in which the lockup clutch is engaged (the internal combustion engine and the axle are connected to each other), when the deceleration request is generated, the fuel cut is carried out under the travel condition, and the restart request is generated in the course of the decrease in the number of revolutions (vehicle speed) caused by the fuel cut. However, this embodiment can be applied to the vehicle travel condition in which the lockup clutch is disengaged, in other words, a state in which the vehicle is traveling at a predetermined vehicle speed, but the internal combustion engine is rotating at the idling number of revolutions.

When the deceleration request (brake operation) is generated under this travel condition, the fuel cut is carried out from the point of view of the fuel economy. As a result, the number of revolutions decreases from the idling number of revolutions. When the restart request is generated in the course of the decrease in the number of revolutions, the above-mentioned starter-less start or the like is carried out, and thus a smooth start as in this embodiment can be carried out.

As described above, in this embodiment, the open timing of the exhaust valves is retarded to the vicinity of the bottom dead center on the expansion stroke end side in the course of the decrease in the rotational speed of the internal combustion engine after the stop of the fuel injection, thereby effectively using the combustion torque of the combustion gas of the fuel caused by the fuel injection upon the restart. As a result, when the restart request is generated after the stop of the fuel injection, and the restart is carried out, the combustion torque acquired by the combustion of the fuel can be effectively used. As a result, the lower limit rotational speed permitting the starter-less start can be decreased so as to increase the ratio of the starter-less start.

Moreover, in this embodiment, the open timing of the exhaust valves is retarded to the vicinity of the bottom dead center on the expansion stroke end side in the course of the decrease in the rotational speed of the internal combustion engine after the stop of the fuel injection, thereby effectively using the combustion torque of the combustion gas of the fuel caused by the fuel injection upon the restart. In addition, the close timing of the intake valves is advanced to the vicinity of the bottom dead center on the intake stroke end side, thereby suppressing the discharge of the fresh air backward to the intake system side upon the transition to the compression stroke. As a result, in addition to the above-mentioned effect, the discharge of the fresh air backward to the intake pipe in the compression stoke is suppressed, and the fresh air or the mixture to be combusted can be increased, resulting in a further increase in the combustion torque, and a more reliable and smooth starter-less start. Moreover, it should be understood that the ratio of the starter start and the number of the activations can be reduced, resulting in an increase in the durability of the starter.

### Second Embodiment

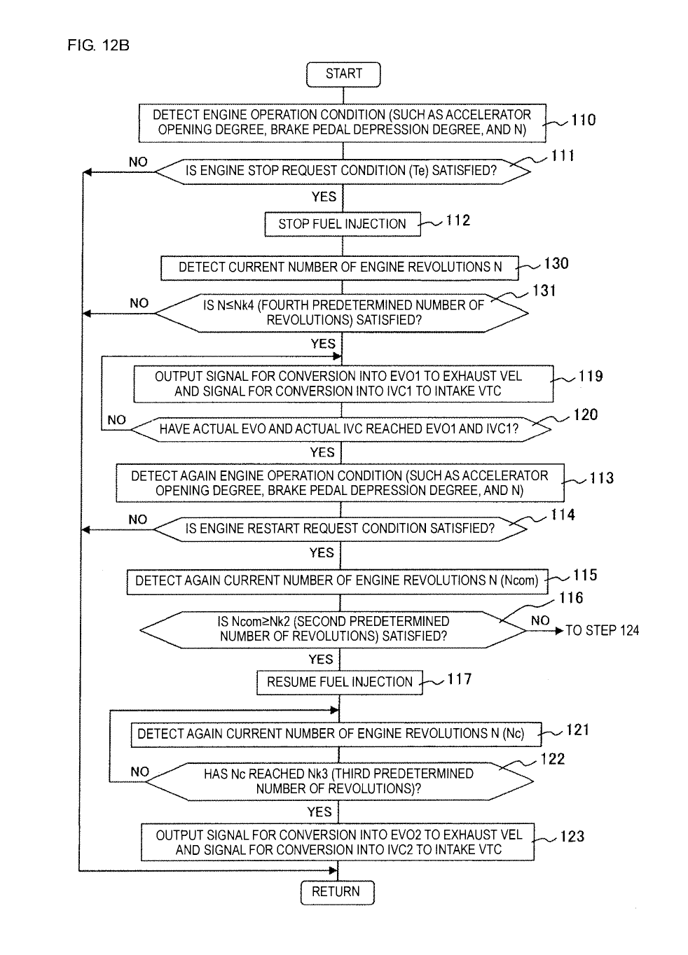

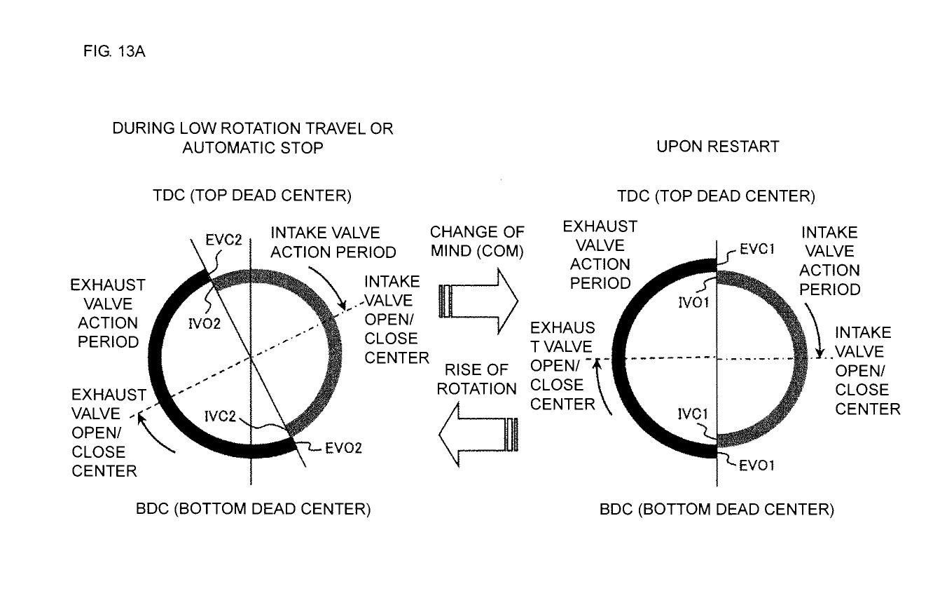

Referring to FIGS. 12A and 12B, a description is now given of a second embodiment of the present invention. In the first embodiment, when the restart request is generated at the number of revolutions equal to or less than the first predetermined number of revolutions Nk1, the open timing of the exhaust valves 5 and the close timing of the intake valves 4 are changed. The second embodiment is different in such a point that the control signals for changing the open timing of the exhaust valves 5 and the close timing of the intake valves 4 are output without waiting for the restart request at the time point Ta at which the number of revolutions N has decreased to be equal to or less than a fourth predetermined number of revolutions Nk4. It should be noted that the same reference numerals in a flowchart illustrated in FIG. 12B as those of the control steps in the flowchart illustrated in FIG. 11 denote the same processing, and a brief description is thus given thereof.

As illustrated in FIG. 12A, it is assumed that the vehicle is in the travel (cruising) state, and the number of revolutions N of the internal combustion engine is, for example, 1,000 rpm. Then, when the engine stop request (vehicle deceleration request) is generated at the time point Te, the fuel injection is stopped at the time point Tic approximately in synchronous with the generation of the engine stop request, and the number of revolutions N decreases. Referring to the corresponding flowchart illustrated in FIG. 12B, in Step 110, the operation state of the internal combustion engine is detected, and, in Step 111, whether or not the engine stop request (the vehicle deceleration request is output at the time point Te) is output is determined based on the release (opening degree) of the accelerator pedal, a brake depression amount (depression degree), and the like. In Step 111, when the engine stop request is determined to be generated, the processing proceeds to Step 112, to thereby stop the fuel injection at the time point Tic approximately in synchronous with the time point Te. Thereafter, the fuel is not supplied, and hence, as illustrated in FIG. 12A, the number of revolutions N of the internal combustion engine decreases.

Then, in Step 130, the current number of revolutions N is detected. Then, the processing proceeds to Step 131, to thereby determine whether or not the detected number of revolutions N has decreased to be equal to or less than the fourth predetermined number of revolutions Nk4 (such as 600 rpm). This fourth predetermined number of revolutions Nk4 is an exhaust valve control revolution number for outputting a control signal to control the open timing of the exhaust valves 5 to retard as described later. Thus, when the number of revolutions N has not decreased to be equal to or less than the fourth predetermined number of revolutions Nk4, which is the exhaust valve control revolution number, the processing proceeds to return. When the number of revolutions N has decreased to be equal to or less than the fourth predetermined number of revolutions Nk4, the processing proceeds to Step 119. In Step 119, in order to increase the start reliability of the starter-less start, the control signals are output to the exhaust VEL 1 and the intake VTC 3 at the time point Ta so that the open/close states of the intake valves 4 and the exhaust valves 5 illustrated on the right side of FIG. 8A are brought about.

When the control signals for changing the close timing of the intake valves 4 and the open timing of the exhaust valves 5 are output at the time point Ta, the open timing of the exhaust valves 5 is changed from the open timing (EVO2) at the automatic stop to the open timing (EVO1) in the vicinity of the bottom dead center on the expansion stroke end side in order to increase the starter-less start capability. Similarly, the close timing of the intake valves 4 is changed from the close timing (IVC2) at the automatic stop to the close timing (IVC1) in the vicinity of the bottom dead center on the intake stroke end side. As a result, the preparation for the starter-less start is completed, and a ready state is brought about.

Then, in Step 113, the operation state in which “change of mind” is output is detected, and the processing further proceeds to Step 114, to thereby determine whether or not the restart request condition is satisfied. When the restart condition is determined to be satisfied at the time point Tcom, in Step 115, the current number of revolutions Ncom is detected, and the processing proceeds to Step 116, to thereby determine whether or not the detected number of revolutions Ncom is equal to or more than the second predetermined number of revolutions Nk2 close to 0 rpm. In Step 116, when the detected number of revolutions Ncom is equal to or more than the second predetermined number of revolutions Nk2, the processing transitions to a restart sequence by means of the starter-less start, and when the detected number of revolutions Ncom is determined to be less than the second predetermined number of revolutions Nk2, the processing transitions to a restart sequence using the starter.

In Step 116, when the number of revolutions Ncom upon the restart request is equal to or more than the second predetermined number of revolutions Nk2, the processing proceeds to Step 117, and the fuel injection is immediately resumed at the time point Tis. In this state, as a result of the execution of the control steps of Steps 131, 119, and 120, at the time point Tb, the exhaust valve open timing is already changed from the open timing (EVO2) at the automatic stop to the open timing (EVO1) in the vicinity of the bottom dead center on the expansion stoke end side, the intake valve close timing is already changed from the close timing (IVC2) at the automatic stop to the close timing (IVC1) in the vicinity of the bottom dead center on the intake stoke end side, and the ready state is brought about. As a result, a sufficient combustion torque can be acquired as in the first embodiment, resulting in an excellent starter-less start. Particularly in this embodiment, as described before, the valve timings have been changed to the valve timings for the starter-less restart in advance, and the ready state is brought about. Thus, an excellent combustion torque can be acquired without a delay, resulting in a reliable starter-less start. Further, in a case of “change of mind” when the number of engine revolutions is rapidly decreasing, the valve timings has been quickly changed to the valve timings for the starter-less restart, similarly resulting in an excellent combustion torque. Even under such a condition that the starter-less start is difficult, the starter-less start can be realized. As a result, the ratio of the starter-less start can further be increased.

Then, the number of revolutions N increases as a result of the starter-less start. In Step 121 after Step 117, the current number of revolutions Nc is detected. In Step 122, when the number of revolutions Nc is determined to be higher than the third predetermined number of revolutions Nk3, the processing proceeds to Step 123, to thereby set again the open timing of the exhaust valves 5 to the open timing (EVO2) advanced by the predetermined angle from the bottom dead center (BDC) on the expansion stroke end side, and set the close timing of the intake valves 4 to the close timing (IVC2) retarded by the predetermined angle from the bottom dead center (BDC) on the intake stroke end side.

It should be noted that, in Step 116, when the number of revolutions Ncom when the restart request is generated is less than the second predetermined number of revolutions Nk2, the processing proceeds to Step 124, to thereby carry out the control steps from Steps 124 to 129 so as to carry out the start by using the starter. It should be noted that, also in this state, as a result of the execution of the control steps of Steps 131, 119, and 120, at the time point Tb, the exhaust valve open timing is already changed from the open timing (EVO2) at the automatic stop to the open timing (EVO1) in the vicinity of the bottom dead center on the expansion stoke end side, and the intake valve close timing is already changed from the close timing (IVC2) at the automatic stop to the close timing (IVC1) in the vicinity of the bottom dead center on the intake stoke end side. Thus, the internal combustion engine is forcibly rotated by the starter. The exhaust valve open timing is changed to the open timing (EVO1), and the intake valve close timing is changed to the close timing (IVC1). Therefore, the starter start can quickly and reliably be carried out by the rotational force of the starter and the action of the increased combustion torque.

On this occasion, according to this embodiment, the fourth predetermined number of revolutions Nk4 is set to the same predetermined number of revolutions as the first predetermined number of revolutions Nk1 according to the first embodiment, but may be set to a different number of revolutions. However, the first predetermined number of revolutions Nk1 according to the first embodiment is in the vicinity of the lower limit number of revolutions permitting the starter-less start while the open timing of the exhaust valves 5 remains to be the open timing (IVO2), and the close timing of the intake valves 4 remains to be the close timing (EVC2). Therefore, if the fourth predetermined number of revolutions Nk4 is set to be the same as the first predetermined number of revolutions Nk1, only when the number of revolutions decreases to be equal to or less than the fourth predetermined number of revolutions Nk4, the open timing of the exhaust valves 5 is changed to the open timing (EVO1), and the close timing of the intake valves 4 is changed to the close timing (IVC1). As a result, the frequency of the control of changing the open timing of the exhaust valves 5 and the close timing of the intake valves 4 can be reduced, which provides such an effect as an increase in the durability of the variable valve actuating mechanism, or a decrease in the control load.

In this way, also in this embodiment, when the restart request is generated after the stop of the fuel injection, and the restart is carried out, the combustion torque acquired by the combustion of the fuel can be effectively used. As a result, the lower limit rotational speed permitting the starter-less start can be decreased so as to increase the ratio of the starter-less start. Moreover, in addition to the effects, for the starter start, the ready state in which the valve timings have been changed to the valve timings for the starter-less restart in advance is brought about, and an excellent combustion torque can thus be acquired without a delay, resulting in a more reliable starter-less start. Moreover, the ratio of the starter start further decreases, and the durability of the starter further increases.

### Third Embodiment

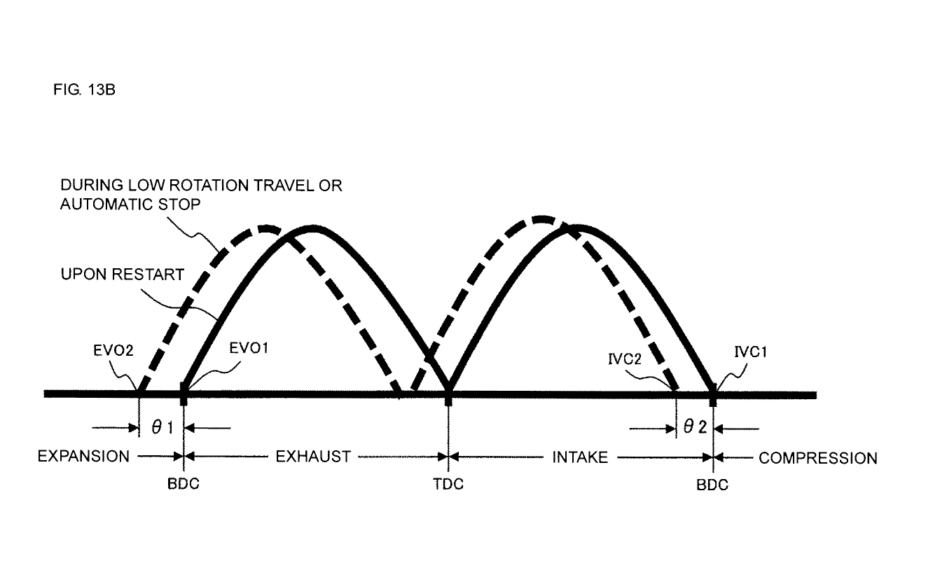

With reference to FIGS. 13A and 13B, a description is now given of a third embodiment of the present invention. In the first embodiment, the exhaust VEL 1 is used for controlling the open timing of the exhaust valves 5, but the third embodiment is different in such a point that the exhaust VTC 2 is used in place of the exhaust VEL 1. Thus, the valve lift of the exhaust valves 5 is not controlled, and the valve timing (phase) is controlled as by the intake VTC 3.

The exhaust VTC 2 and the intake VTC 3 according to this embodiment include practically the same configuration, and both the VTCs 2 and 3 are different from the intake VTC according to the first and second embodiments, and have the most retarded positions as the default positions. In other words, the coil springs 55 and 56 for biasing the vanes 32b of the vane member 32 bias the vanes 32b to the retarded side, and the vanes 32b are set to the most retarded phase when the hydraulic pressure is not supplied. Then, this state is in a phase illustrated on the right side of FIG. 13A. According to this embodiment, as described above, the open timing (EVO1) of the exhaust valves 5 and the close timing (IVC1) of the intake valves 4 upon the restart are both default positions, and are the mechanically stable positions.

A diagram on the left side of FIG. 13A illustrates open/close states of the exhaust valves 5 and the intake valves 4 during the low rotation travel (cruising) and the automatic stop after transition from this travel state of the vehicle to the automatic stop state. Moreover, a valve characteristic represented by the broken line of FIG. 13B corresponds to the open/close states of the exhaust valves 5 and the intake valves 4 on the left side of FIG. 13A. Then, the open timing of the exhaust valves 5 is set to the general open timing (EVO2) advanced by the predetermined angle from the bottom dead center (BDC) on the expansion stroke end side, and the exhaust valves 5 start to open at the open timing (EVO2) in the second half of the expansion stroke, and exhaust the exhaust gas in the exhaust stroke. Then, the close timing of the exhaust valves 5 is set to the close timing (EVC2) advanced by the predetermined angle from the top dead center (TDC) on the exhaust stroke end side, and the exhaust valves 5 are closed before the top dead center (TDC) on the exhaust stroke end side.

On the other hand, the open timing (IVO2) of the intake valves 4 is set to a timing approximately the same as the close timing (EVC2) of the exhaust valves 5, and is advanced by the predetermined angle from the top dead center (TDC) on the intake stroke start side. Thus, the intake valves 4 start to open at the open timing (IVO2) in the second half of the exhaust stroke, and suck the fresh air in the intake stroke. Then, the close timing of the intake valves 4 is set to the close timing (IVC2) advanced by the predetermined angle from the bottom dead center (BDC) on the intake stroke end side, and the intake valves 4 are closed in the second half of the intake stroke. As a result, the intake stroke decreases. Thus, the pump loss decreases, and the fuel economy performance increases during the cruising.

Then, when, in this state, the deceleration request is generated, the automatic stop process (sequence) starts. When the restart request (re-acceleration request) is generated by “change of mind” in the course of a further decrease in the rotational speed, the open/close states of the exhaust valves 5 and the intake valves 4 are changed, as illustrated in a diagram on the right side of FIG. 13A. Moreover, a valve characteristic represented by the solid line of FIG. 13B corresponds to the open/close states of the exhaust valves 5 and the intake valves 4 on the right side of FIG. 13A. Then, when the restart request is generated, the open timing of the exhaust valves 5 is changed to the open timing (EVO1) in the vicinity of the bottom dead center (BDC) on the expansion stroke end side. In other words, as illustrated in FIG. 13B, the open timing of the exhaust valves 5 is retarded by θ1 from the open timing (EVO2) to the open timing (EVO1), and, in this case, the exhaust VTC 2 is in the state of the most retarded phase. Thus, as illustrated on the right side of FIG. 13A, the open timing (EVO1) of the exhaust valves 5 is set to the vicinity of the bottom dead center on the expansion stroke end side. The exhaust valves 5 start to open at the open timing (EVO1) in this state, and exhaust the exhaust gas in the exhaust stroke. Then, the close timing of the exhaust valves 5 is set to the close timing (EVC1) in the vicinity of the top dead center (TDC) on the exhaust stroke end side.

On the other hand, the open timing (IVO1) of the intake valves 4 is set to a timing approximately the same as the close timing (EVC1) of the exhaust valves 5, and is set to the vicinity of the top dead center (TDC) on the intake stroke start side. Thus, the open timing (IVO1) for the restart is retarded from the open timing (IVO2) during the automatic stop, and the intake valves 4 are opened in the vicinity of the top dead center (TDC) on the intake stroke start side. Thus, the intake valves 4 start to open at the open timing (IVO1) at the beginning of the intake stroke, and suck the fresh air in the intake stroke. Then, the close timing of the intake valves 4 is set to the close timing (IVC1) in the vicinity of the bottom dead center (BDC) on the intake stroke end side. According to this embodiment, the intake VTC 3 is used, and the close timing of the intake valves 4 is thus retarded by θ2, which is the same amount as that for the open timing. Moreover, according to this embodiment, the intake VTC 3 has the mechanical stable position (default) also in the vicinity of the most retarded position.

Further, when the restart has succeeded, and the number of revolutions of the internal combustion engine increases to reach a predetermined stable number of revolutions, the open/close states of the exhaust valves 5 and the intake valves 4 return from the restart state on the right side of FIG. 13A to a state of the automatic stop or the low rotation on the left side of FIG. 13A.

Then, the intake valves 4 and the exhaust valves 5 are controlled in accordance with the flowchart of FIG. 11 or 12B. Thus, also in this embodiment, when the restart request is generated after the stop of the fuel injection, and the restart is carried out, the same exhaust valve open timing (EVO1) as those of the first and second embodiments is set. Thus, the combustion torque acquired by the combustion energy of the fuel can be effectively used similarly. As a result, the lower limit rotational speed permitting the starter-less start can be decreased so as to increase the ratio of the starter-less start. Moreover, in addition to the above-mentioned effects, IVC1 is close to the bottom dead center, and the fresh air is thus not discharged backward to the intake system in the compression stroke as in the first and second embodiments. As a result, the charging efficiency can be increased, the combustion torque can further be increased, the lower limit rotational speed permitting the starter-less start can be further decreased, and the ratio of the starter-less start can be further increased. On this occasion, the valve overlap amount is set so as not to practically exist as in the first embodiment, but a center phase of the overlap between the close timing (EVC1) of the exhaust valves 5 and the open timing (IVO1) of the intake valves 4 is set approximately to the top dead center. As a result, the residue of the combusted gas in the cylinder caused by the closure of the exhaust valves before the top dead center can be suppressed, and the combustion torque can be further increased. As a result, such an effect that the combustion torque upon the starter-less start is further increased is obtained.

Moreover, the close timing (IVC2) of the intake valves 4 is advanced to the front side of the bottom dead center on the intake stroke end side while the internal combustion engine is rotating. Thus, the intake stroke of the piston is reduced, the pump loss can thus be reduced, and such an effect as an increase in the fuel economy during the cruising is obtained.

Moreover, the overlap center phase is advanced. Thus, the residue of the combustion gas in the cylinder caused by the closure of the exhaust valves 5 before the top dead center on the exhaust stroke end side further reduces the pump loss, and such an effect as a further increase in the fuel economy during the cruising is obtained.

Further, as described before, the valve overlap amount does not practically exist as in the first embodiment. In the course of the changes in the open timing of the exhaust valves 5 and the close timing of the intake valves 4 after the restart request, discharge of the fresh air in the combustion chamber toward the intake port is suppressed and also the amount of the discharged fresh air itself can be reduced. As a result, the air-fuel ratio can be stabilized, and the starter-less start can be reliably carried out.

In the above-mentioned embodiment, the open timing (EVO) and the close timing (EVC) of the exhaust valves 5 and the open timing (IVO) and the close timing (IVC) of the intake valves 4 may be prescribed based on absolute lift start points and lift end points, or may be prescribed based on start-side ramp lift points and end-side ramp lift points determined by minute ramp sections (buffer sections) respectively existing in vicinities of the absolute lift start points and lift end points.

The ramp section refers to a minute section from the absolute lift start point (0 mm) to a start-side ramp lift point (approximately 0.1 mm) and a minute section from the absolute lift end point (0 mm) to an end-side ramp lift point (approximately 0.1 mm). Ramp lift amounts in these ramp sections are very small. Thus, the flow speed when the air or the exhaust gas flows is extremely large, and the so-called choking (flow rate choking effect) is liable to occur. Therefore, the effective gas exchange becomes difficult, and an intermediate part between the start-side ramp lift point and the end-side ramp lift point excluding these ramp sections has been used as a practically effective lift section.

A combustion cycle in the area of the extremely low number of revolutions in the starter-less start subject to the present invention is now considered. The starter-less start is carried out in the area of the extremely low number of revolutions lower than an area of a normal number of revolutions, and the gas exchange of the air, the exhaust gas, and the like is also carried out in the area of the extremely low number of revolutions. The amount of the gases to be exchanged is small in this area, and the choking is thus less liable to occur. In other words, the gas exchange is easily carried out even at the start-side ramp lift point and the end-side ramp lift point. Thus, as the practically effective lift start point and lift end point, a lift start point and a lift end point smaller than the start-side ramp lift point and the end-side ramp lift point can be set for a higher precision. In other words, the practically effective start-side lift point and end-side lift point in the extremely low rotation area may be considered to exist between the absolute lift start point (0 mm) and the start-side ramp lift point and between the end-side ramp lift point and the absolute lift end point (0 mm).

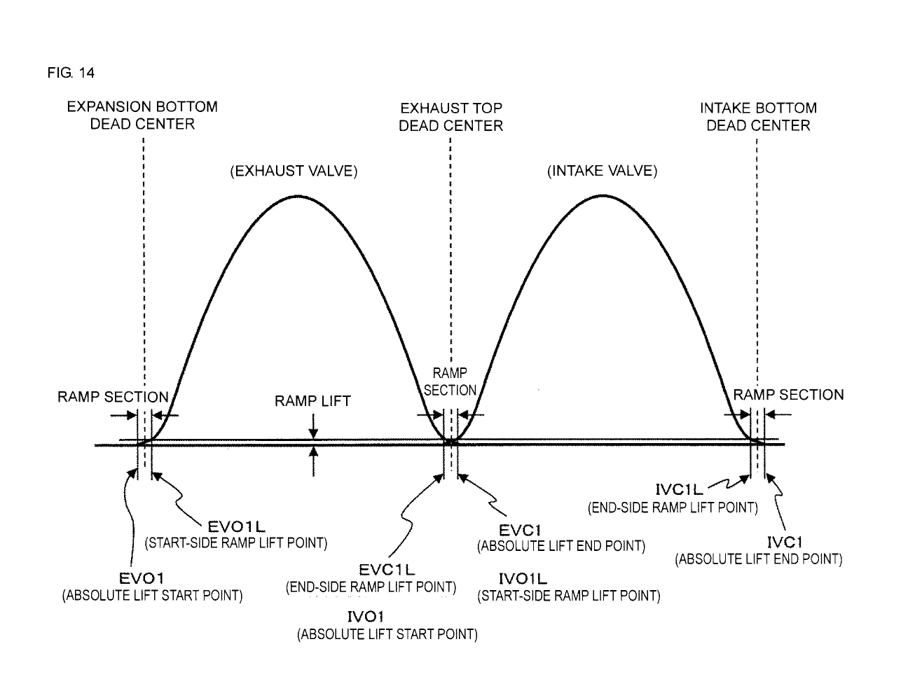

Thus, as illustrated in FIG. 14, in order to align the practically effective lift start point of the open timing of the exhaust valves 5 to the expansion bottom dead center, a start-side ramp lift point (EVO1L) of the exhaust valves 5 only needs to be set to a point slightly after the expansion bottom dead center, and the absolute lift start point (EVO1) only needs to be set to a point slightly before the expansion bottom dead center. In this way, the effective open timing of the exhaust valves 5 can be precisely aligned with the vicinity of the expansion bottom dead center.

Similarly, in order to align the practically effective lift end point of the close timing of the intake valves 4 to the intake bottom dead center, an end-side ramp lift point (IVC1L) of the intake valves 4 only needs to be set to a point slightly before the intake bottom dead center, and the absolute lift end point (IVC1) only needs to be set to a point slightly after the intake bottom dead center. In this way, the effective close timing of the intake valves 4 can be precisely aligned with the vicinity of the intake bottom dead center.

Further, the same method can be applied to the open timing (IVO) of the intake valves 4 and the close timing (EVC) of the exhaust valves 5 for the setting. It should be noted that an end-side ramp lift point (EVC1L) of the exhaust valves 5 and the absolute lift start point (IVO1) of the intake valves 4 in the vicinity of the exhaust top dead center are set to points slightly before the exhaust top dead center, and the absolute lift end point (EVC1) of the exhaust valves 5 and a start-side ramp lift point (IVO1L) of the intake valves 4 in the vicinity of the exhaust top dead center are set to points slightly after the exhaust top dead center. As a result, the effective open timing of the intake valves 4 and the effective close timing of the exhaust valves 5 can be precisely aligned with the vicinity of the exhaust top dead center. Moreover, the end-side ramp lift point (EVC1L) of the exhaust valves 5 and the absolute lift start point (IVO1) of the intake valves 4 may be the same timing, and the absolute lift end point (EVC1) of the exhaust valves 5 and the start-side ramp lift point (IVO1L) of the intake valves 4 in the vicinity of the exhaust top dead center may also be the same timing.

In the embodiments, as the variable valve actuating mechanism, the configuration in which the lift control mechanism (VEL) is provided on the exhaust side, and the valve timing control mechanism (VTC) is provided on the intake side, and the configuration in which the valve timing control mechanisms (VTCs) are provided on both the exhaust side and the intake side are described. However, the variable valve actuating mechanism is not limited to these configurations, and is not particularly limited as long as the variable valve actuating mechanism does not depart from the gist of the present invention. Moreover, an electric power or a hydraulic pressure may be used as the conversion energy of the variable valve actuating mechanism.

Moreover, the automatic stop/restart control system according to the present invention can be applied to a gasoline engine, a diesel engine, and an internal combustion engine using other fuels (such as hydrogen and alcohol). Further, the automatic stop/restart control system can be configured to act under a cruising condition or a coasting condition with a gentle deceleration without braking, and under a rapid deceleration condition accompanying the braking. On this occasion, the internal combustion engine and the axle may be disconnected from each other or may be remained in the connected state by a mechanism such as the lockup clutch for intermittently connecting the internal combustion engine and the axle to each other. Moreover, as described before, the automatic stop/restart control system can be applied to a vehicle travel condition under which the lockup clutch is not engaged, such as a case where the vehicle is traveling at a predetermined low vehicle speed, but the internal combustion engine itself is in the idling rotation state.

As described above, according to one embodiment of the present invention, the open timing of the exhaust valves is retarded to the vicinity of the bottom dead center of the expansion stroke in the course of the decrease in the rotational speed of the internal combustion engine after the stop of the fuel injection, thereby effectively using the combustion torque of the combustion gas of the fuel caused by the fuel injection upon the restart. As a result, when the restart request is generated after the stop of the fuel injection, and the restart is carried out, the combustion torque acquired by the combustion of the fuel can be effectively used. As a result, the lower limit rotational speed permitting the starter-less start can be decreased so as to increase the ratio of the starter-less start.

Moreover, according to one embodiment of the present invention, the open timing of the exhaust valves is retarded to the vicinity of the bottom dead center of the expansion stroke in the course of the decrease in the rotational speed of the internal combustion engine after the stop of the fuel injection, thereby effectively using the combustion torque of the combustion gas of the fuel caused by the fuel injection upon the restart. In addition, the close timing of the intake valves is advanced to the vicinity of the bottom dead center of the intake stroke, thereby suppressing the discharge of fresh air backward to the intake system side upon the transition to the compression stroke. As a result, in addition to the above-mentioned effects, the fresh air is not discharged backward to the intake pipe in the compression stroke. Thus, the charging efficiency of the fresh air or the mixture can be increased, the combustion torque can be further increased, the lower limit rotational speed permitting the starter-less start can be further decreased, and the ratio of the starter-less start can be further increased.

(1) An automatic stop/restart control system for an internal combustion engine, comprising: an engine stop device configured to stop fuel injection from a fuel injection valve in response to generation of an engine stop request during an operation of an internal combustion engine; and a restart device configured to restart the fuel injection from the fuel injection valve and to open an exhaust valve in a vicinity of a bottom dead center on an expansion stroke end side, in response to generation of a restart request by a driver in a course of a decrease in number of revolutions of the internal combustion engine during stop of the fuel injection by the engine stop device.

(2) An automatic stop/restart control system for an internal combustion engine, comprising: an engine stop device configured to stop fuel injection from a fuel injection valve in response to generation of an engine stop request during an operation of an internal combustion engine; and a restart device configured to restart the fuel injection from the fuel injection valve and to open an exhaust valve in a vicinity of a bottom dead center on an expansion stroke end side and close an intake valve in a vicinity of a bottom dead center on an intake stroke end side, in response to generation of a restart request by a driver in a course of a decrease in number of revolutions of the internal combustion engine during stop of the fuel injection by the engine stop device.

(3) An automatic stop/restart control system for an internal combustion engine according to (1) or (2), wherein in response to the generation of the restart request by the driver, when the number of revolutions of the internal combustion engine is more than a first predetermined number of revolutions, the restart device opens the exhaust valve on a front side of the bottom dead center on the expansion stroke end side; and when the number of revolutions of the internal combustion engine decreases to be equal to or less than the first predetermined number of revolutions, the restart device opens the exhaust value in the vicinity of the bottom dead center on the expansion stroke end side.

(4) An automatic stop/restart control system for an internal combustion engine according to (3), wherein in response to the generation of the restart request by the driver, when the number of revolutions of the internal combustion engine decreases to be less than a second predetermined number of revolutions that is lower than the first predetermined number of revolutions, the restart device uses a starter to restart the internal combustion engine.

(5) An automatic stop/restart control system for an internal combustion engine, comprising: an engine stop device for stopping fuel injection from a fuel injection valve in response to generation of an engine stop request during an operation of an internal combustion engine; and a restart device configured to open an exhaust valve in a vicinity of a bottom dead center on an expansion stroke end side, when number of revolutions of the internal combustion engine decreases to be equal to or less than a predetermined exhaust valve control number of revolutions during stop of the fuel injection by the engine stop device, the restart device configured to restart the fuel injection from the fuel injection valve at the valve timing in response to generation of a restart request by a driver.

(6) An automatic stop/restart control system for an internal combustion engine, comprising: an engine stop device for stopping fuel injection from a fuel injection valve in response to generation of an engine stop request during an operation of an internal combustion engine; and a restart device configured to open an exhaust valve in a vicinity of a bottom dead center on an expansion stroke end side and close an intake valve in a vicinity of a bottom dead center on an intake stroke end side, when number of revolutions of the internal combustion engine decreases to be equal to or less than a predetermined exhaust valve control number of revolutions during stop of the fuel injection by the engine stop device, the restart device further configured to restart the fuel injection from the fuel injection valve at the valve timings in response to generation of a restart request by a driver.

(7) An automatic stop/restart control system for an internal combustion engine according to (5) or (6), wherein in response to the generation of the restart request by the driver, when the number of revolutions of the internal combustion engine decreases to be less than a second predetermined number of revolutions that is lower than the exhaust valve control number of revolutions, the restart device uses a starter to restart the internal combustion engine.

(8) An automatic stop/restart control system for an internal combustion engine according to (4) or (7), wherein the restart device drives the starter after a predetermined period from the stop of rotation of the internal combustion engine, and then restarts the fuel injection from the fuel injection valve.

(9) A variable valve actuating apparatus, comprising an exhaust-side variable valve actuating mechanism configured to control an open/close state of an exhaust valve of an internal combustion engine, the exhaust-side variable valve actuating mechanism configured to be driven and controlled by an exhaust valve control signal from a control apparatus which calculates the open/close state of the exhaust valve, wherein when an engine stop request is generated during an operation of the internal combustion engine so as to stop fuel injection from a fuel injection valve, and when a restart request by a driver is generated in a course of a decrease in number of revolutions of the internal combustion engine, the exhaust-side variable valve actuating mechanism transitions to a mechanically stable position so as to open the exhaust valve in a vicinity of a bottom dead center on an expansion stroke end side.

(10) A variable valve actuating apparatus according to (9), further comprising an intake-side variable valve actuating mechanism in addition to the exhaust-side variable valve actuating mechanism, the intake-side variable valve actuating mechanism configured to control an open/close state of an intake valve by an intake valve control signal from the control apparatus, wherein when the restart request by the driver is generated, the intake-side variable valve actuating mechanism transitions to a mechanically stable position so as to close the intake valve in a vicinity of a bottom dead center on an intake stroke end side.

(11) A variable valve actuating apparatus, comprising an exhaust-side variable valve actuating mechanism configured to control an open/close state of an exhaust valve of an internal combustion engine, the exhaust-side variable valve actuating mechanism configured to be driven and controlled by an exhaust valve control signal from a control apparatus which calculates the open/close state of the exhaust valve, wherein when the engine stop request is generated during the operation of the internal combustion engine so as to stop the fuel injection from the fuel injection valve, and when the number of revolutions of the internal combustion engine decreases to be equal to or less than a predetermined exhaust valve control number of revolutions in the course of the decrease in the number of revolutions of the internal combustion engine, the exhaust-side variable valve actuating mechanism transitions to the mechanically stable position so as to open the exhaust valve in the vicinity of the bottom dead center on the expansion stroke end side.

(12) A variable valve actuating apparatus according to (11), further comprising an intake-side variable valve actuating mechanism in addition to the exhaust-side variable valve actuating mechanism, the intake-side variable valve actuating mechanism configured to control an open/close state of an intake valve by an intake valve control signal from the control apparatus, wherein when the number of revolutions of the internal combustion engine decreases to be equal to or less than the predetermined exhaust valve control number of revolutions, the intake-side variable valve actuating mechanism transitions to a mechanically stable position so as to close the intake valve in a vicinity of a bottom dead center on an intake stroke end side.

According to one aspect of the embodiments, when the restart request is generated after the stop of the fuel injection, and the restart is carried out, the combustion torque acquired by the combustion of the fuel may be effectively used. As a result, a lower limit rotational speed permitting the starter-less start may be decreased so as to increase the ratio of the starter-less start.

According to another aspect of the embodiments, in addition to the effects described before, the combustion torque may further be increased, and the lower limit rotational speed permitting the starter-less start may be further decreased, thereby further increasing the ratio of the starter-less start.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

This application claims priority to Japanese Patent Application No. 2014-126766 filed on Jun. 20, 2014. The entire disclosure of Japanese Patent Application No. 2014-126766 filed on Jun. 20, 2014 including specification, claims, drawings and summary is incorporated herein by reference in its entirety.

The entire disclosure of Japanese Patent Application Publication Nos. 2010-242621, 2003-172112, and 2012-127219 including specification, claims, drawings and summary is incorporated herein by reference in its entirety.

What is claimed is:

1. An automatic stop/restart control system for an internal combustion engine, comprising:
an engine stop device configured to stop fuel injection from a fuel injection valve in response to generation of an engine stop request during an operation of an internal combustion engine; and
a restart device configured to restart the fuel injection from the fuel injection valve and to open an exhaust valve in a vicinity of a bottom dead center on an expansion stroke end side, in response to generation of a restart request by a driver in a course of a decrease in number of revolutions of the internal combustion engine during stop of the fuel injection by the engine stop device.

2. An automatic stop/restart control system for an internal combustion engine according to claim 1, wherein the restart device closes an intake valve in a vicinity of a bottom dead center on an intake stroke end side.

3. An automatic stop/restart control system for an internal combustion engine according to claim 2, wherein:
in response to the generation of the restart request by the driver, when the number of revolutions of the internal combustion engine is more than a first predetermined number of revolutions, the restart device opens the exhaust valve on a front side of the bottom dead center on the expansion stroke end side; and
when the number of revolutions of the internal combustion engine decreases to be equal to or less than the first predetermined number of revolutions, the restart device opens the exhaust value in the vicinity of the bottom dead center on the expansion stroke end side.

4. An automatic stop/restart control system for an internal combustion engine according to claim 3, wherein in response to the generation of the restart request by the driver, when the number of revolutions of the internal combustion engine decreases to be less than a second predetermined number of revolutions that is lower than the first predetermined number of revolutions, the restart device uses a starter to restart the internal combustion engine.

5. An automatic stop/restart control system for an internal combustion engine, comprising:
an engine stop device configured to stop fuel injection from a fuel injection valve in response to generation of an engine stop request during an operation of an internal combustion engine; and
a restart device configured to open an exhaust valve in a vicinity of a bottom dead center on an expansion stroke end side, when number of revolutions of the internal combustion engine decreases to be equal to or less than a predetermined exhaust valve control revolution number during stop of the fuel injection by the engine stop device, and to restart the fuel injection from the fuel injection valve at the valve timing in response to generation of a restart request by a driver.

6. An automatic stop/restart control system for an internal combustion engine according to claim 5, wherein during the stop of the fuel injection by the engine stop device, when the number of revolutions of the internal combustion engine decreases to be equal to or less than the predetermined exhaust valve control revolution number, an intake valve is closed in a vicinity of a bottom dead center on an intake stroke end side.

7. An automatic stop/restart control system for an internal combustion engine according to claim 5, wherein in response to the generation of the restart request by the driver, when the number of revolutions of the internal combustion engine decreases to be less than a second predetermined number of revolutions that is lower than the exhaust valve control revolution number, the restart device uses a starter to restart the internal combustion engine.

8. An automatic stop/restart control system for an internal combustion engine according to claim 7, wherein the restart device drives the starter after a predetermined period from the stop of rotation of the internal combustion engine, and then restarts the fuel injection from the fuel injection valve.

9. A variable valve actuating apparatus, comprising an exhaust-side variable valve actuating mechanism configured to control an open/close state of an exhaust valve of an internal combustion engine, the exhaust-side variable valve actuating mechanism configured to be driven and controlled by an exhaust valve control signal from a control apparatus which calculates the open/close state of the exhaust valve,
wherein when an engine stop request is generated during an operation of the internal combustion engine so as to stop fuel injection from a fuel injection valve, and when a restart request by a driver is generated in a course of a decrease in number of revolutions of the internal combustion engine, the exhaust-side variable valve actuating mechanism transitions to a mechanically stable position so as to open the exhaust valve in a vicinity of a bottom dead center on an expansion stroke end side.

10. A variable valve actuating apparatus according to claim 9, further comprising an intake-side variable valve actuating mechanism configured to control an open/close state of an intake valve by an intake valve control signal from the control apparatus in addition to the exhaust-side variable valve actuating mechanism,
wherein when the restart request by the driver is generated, the intake-side variable valve actuating mechanism transitions to a mechanically stable position so as to close the intake valve in a vicinity of a bottom dead center on an intake stroke end side.

11. A variable valve actuating apparatus according to claim 9, wherein when the engine stop request is generated during the operation of the internal combustion engine so as to stop the fuel injection from the fuel injection valve, and when the number of revolutions of the internal combustion engine decreases to be equal to or less than a predetermined exhaust valve control number of revolutions in the course of the decrease in the number of revolutions of the internal combustion engine, the exhaust-side variable valve actuating mechanism transitions to the mechanically stable position so as to open the exhaust valve in the vicinity of the bottom dead center on the expansion stroke end side.

12. A variable valve actuating apparatus according to claim 11, further comprising an intake-side variable valve actuating mechanism configured to control an open/close state of an intake valve by an intake valve control signal from the control apparatus in addition to the exhaust-side variable valve actuating mechanism,
wherein when the number of revolutions of the internal combustion engine decreases to be equal to or less than the predetermined exhaust valve control revolution number, the intake-side variable valve actuating mechanism transitions to a mechanically stable position so as to close the intake valve in a vicinity of a bottom dead center on an intake stroke end side.
